(19) United States
(12) Patent Application Publication
(10) Pub. No.: US 2026/0246410 A1
(43) Pub. Date: Aug. 20, 2026

(54) METHODS AND APPARATUS TO DETECT A STALL CONDITION OF A MOTOR

(71) Applicant: Texas Instruments Incorporated, Dallas, TX (US)

(72) Inventors: Sameer Pradeep Kulkarni, Pune (IN); Amrtanshu Bharadwaj, Ghaziabad (IN); Karthikeya Panduranga Ayyalaraju, Anantapur (IN); Sreenath Puthumana, Mananthavady, Wayanad (IN); Prasad Kulkarni, Bangalore (IN)

(21) Appl. No.: 19/287,198

(22) Filed: Jul. 31, 2025

(30) Foreign Application Priority Data
Feb. 19, 2025 (IN) 202541014311

(51) Int. Cl. H02P 29/024; H02P 21/22

(52) U.S. Cl. CPC H02P 29/024; H02P 21/22

(57) ABSTRACT

In an embodiment, an electronic circuit includes: a first terminal configured to be coupled to a motor; and a controller configured to: determine a driving state of the motor; determine a current flowing through a coil of the motor based on the driving state; compute energy losses of the motor based on a resistance value of the motor, a self-inductance value of the motor, and the current; and detect a stall condition of the motor based on the energy losses, the current, and the driving state.

### CROSS-REFERENCE TO RELATED APPLICATION

This patent application claims the benefit of and priority to Indian Provisional Patent Application No. 202541014311, filed Feb. 19, 2025, which Application is hereby incorporated herein by reference in its entirety.

### TECHNICAL FIELD

The present disclosure relates generally to an electronic system and method and, in particular embodiments, to methods and apparatus to detect a stall condition of a motor.

### BACKGROUND

Some electrical motors have a fixed stator that interacts with a movable rotor causing rotation of the rotor. The rotor typically includes multiple magnets embedded in or connected to the rotor, and the stator typically includes multiple conductive windings. Electrical current in the windings generates a rotating magnetic field that interacts with the magnets of the rotor, causing the rotor to rotate.

“Sensorless” motor control refers to an approach in which one or more characteristics of an electrical motor, such as motor speed or rotor position, are mathematically derived. Sensorless motor control typically avoids the use of separate speed and position sensors that are mechanically attached to a motor.

### SUMMARY

In accordance to an embodiment, an electronic circuit includes: a first terminal configured to be coupled to a motor; and a controller configured to: determine a driving state of the motor; determine a current flowing through a coil of the motor based on the driving state; compute energy losses of the motor based on a resistance value of the motor, a self-inductance value of the motor, and the current; and detect a stall condition of the motor based on the energy losses, the current, and the driving state.

In accordance to an embodiment, a device includes: a driver configured to be coupled to a motor; and a controller configured to: determine a first current flowing through a first coil of the motor when the driver applies a first voltage to the first coil; determine a second current flowing through a second coil when the driver applies a second voltage to the second coil of the motor; determine an active energy of the motor and a reactive energy of the motor based on the first voltage, the first current, the second voltage, and second current; and determine a stall condition of the motor based on the active energy and reactive energy.

In accordance to an embodiment, a method includes: determining, by a controller, a driving operating state of a motor; sensing a current flowing through a coil of the motor based on the driving operating state; computing, by the controller, energy losses of the motor based on a resistance value of the motor, a self-inductance value of the motor, and the current; and detecting a stall condition of the motor based on the energy losses, the current, and the driving operating state.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates example waveforms that depict a phase shift between back-EMF and coil current in different motor loading situations;

FIG. 2 is a block diagram of an example motor control system that includes an motor controller and a motor, according to an embodiment of the present disclosure;

FIG. 3 illustrates an example timing diagram to depict example voltage states of a full bridge configuration, according to an embodiment of the present disclosure;

FIG. 4 is a schematic diagram of example full bridge circuits that depict how transistors of the example full bridge circuits configure the voltage states of FIG. 3 and the driving operating state of the motor of FIG. 2, according to an embodiment of the present disclosure;

FIG. 5 is a block diagram of an example implementation of the protection circuit of FIG. 2, according to an embodiment of the present disclosure;

FIG. 6 illustrate example tables depicting an action the energy compute circuitry of FIG. 5 takes on the first current i_{A} and takes on the second current i_{B} based on a driving operating state of the first motor phase A and the driving operating state of the second motor phase B;

FIG. 7 is an example graph of a function ƒ(x) over a time period of one electrical cycle, according to an embodiment of the present disclosure;

FIGS. 8A and 8B are flowcharts of an embodiment method for the protection circuit of FIG. 5; and

FIGS. 9A, 9B, 9C, and 9D (collectively “FIG. 9”) illustrate example simulation results of flux values vs speed for different motors when the motor is stalled and when the motor is running, according to an embodiment of the present disclosure.

Corresponding numerals and symbols in different figures generally refer to corresponding parts unless otherwise indicated. The figures are drawn to clearly illustrate relevant aspects of preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates various specific details to provide an in-depth understanding of several example embodiments according to the description. The embodiments may be obtained without one or more of the specific details, or with other methods, components, materials and the like. In some cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events.

Embodiments of the present disclosure are described in specific contexts, e.g., a stepper motor. Some embodiments may be used in other types of actuators, e.g., brushless DC motor.

Some motors that implement sensorless motor control are stepper motors. A stepper motor system may be an open-loop position control system including a motor driver integrated circuit (IC) that drives the motor. Sensorless motor control may be used over sensor-based motors because external components, such as encoders or Hall sensors, add cost to sensor-based systems.

While sensorless motor control reduces costs, sensorless motor control may introduce a different problem: there is no feedback from the motor to the motor driver to let the driver IC know if the motor is running or stalled. In many applications, knowing the status of the motor may be beneficial-either for diagnostics purposes or for position sensing. Diagnostic purposes include being able to detect if the motor is jammed or overloaded. Position sensing purposes include being able to detect if the motor has reached failure or hit a physical obstruction. In some scenarios, applications over-drive the motor in an attempt to overcome the failure or physical obstruction, reducing the efficiency of the system. Without stall detection, the motor driver may continue to drive through the physical obstruction or failure, possibly causing audible noise and mechanical failures.

In some examples, sensorless stall detection methods are implemented by the driver IC, also referred to as a “motor controller,” that can address the aforementioned negative effects and may ensure that the motor is not overloaded or obstructed.

Conventional sensorless stall detection solutions do not detect stall reliably across wide range of operating parameters such as supply voltage, operating speed, and loading conditions. For example, some conventional sensorless stall detection methods assume a sinusoidal current waveform of a current through a coil and calculate a phase difference (e.g., a phase angle or phase shift) between the voltage of the motor (e.g., back electromotive force) and the coil current. For example, some sensorless stall detection methods assume a current through a coil based on voltages driving the motor to detect a stall. In some examples, the current through the motor coils can be used to detect a stall condition of the motor because when the coil current is zero, the voltage across the coil is equal to the back electromotive force (BEMF) of the coil. The back EMF is the voltage generated by the motor as the armature spins inside the stator. The back EMF can be expressed using Equation 1:

$$BEMF = - p \times {Ψ}_{m} \times ω \times sin ( p ω t ) \qquad Equation 1$$

In Equation 1, BEMF refers to the back EMF of the motor m, p refers to the number of pole pairs created by the windings of the motor, which directly influence the speed and torque characteristics of the motor, ψₘ is the maximum magnetic flux of the motor and is a constant specific to the motor, and w is the angular speed of the motor. The BEMF is therefore sinusoidal in nature and directly proportional to the motor speed (ω). A motor, when spinning fast, produces more BEMF than when spinning slower. And when the motor is stalled, no BEMF is produced.

The sensorless stall detection method of assuming the coil current can be problematic because there is no actual current measurement happening and, thus, the assumption could be incorrect. For example, the current is assumed based on measuring the voltages generated by the motor driver and expecting the coil current to be equal to the ratio of the measured voltage and resistance of the coil. But in some examples, the resistance of the coil may be too high and the driven voltage may be insufficient to drive the current to the expected level.

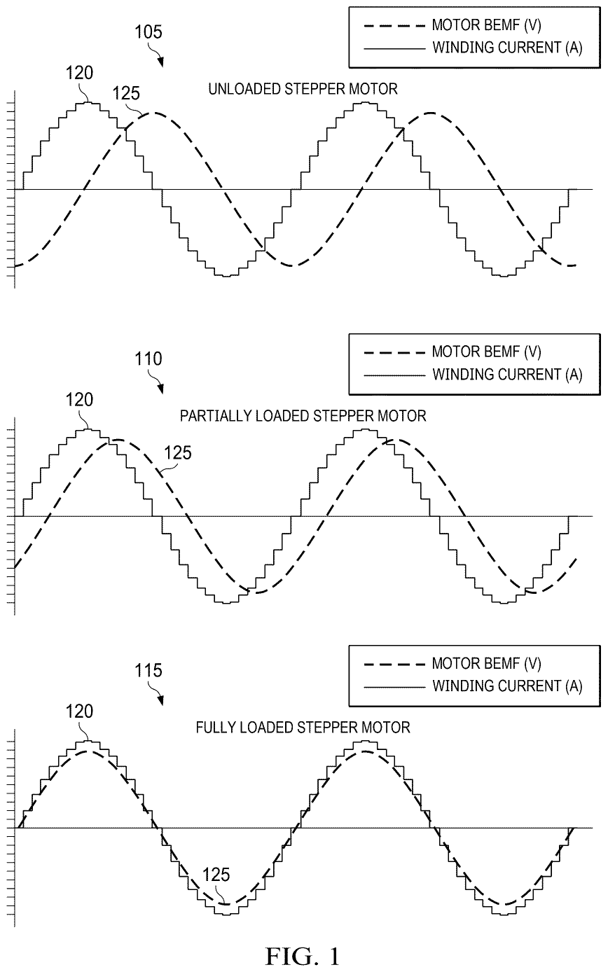

Another problem associated with conventional sensorless stall detection methods is assuming that the current through the coil is a sinusoidal waveform. This may be problematic because the characteristics of the coil may distort the sinusoidal waveform, such as any non-linear coil characteristics. Conventional sensorless stall detection methods assume a sinusoidal waveform because the BEMF waveform and the coil current waveform have a distinct relationship with respect to the loading of the motor. For example, turning to FIG. 1, waveforms 105, 110, and 115 are shown to illustrate a phase shift between back-EMF and coil current in different motor loading situations. In FIG. 1, the first waveform 105, the second waveform 110, and the third waveform 115 include a coil current waveform 120 and a back-EMF waveform 125.

In the illustrated example of FIG. 1, the first waveform 105 illustrates a phase shift between the coil current waveform 120 and the back-EMF waveform 125 when the motor is unloaded. In some examples, the motor loading is referred to as mechanical torque load of the motor. In the first waveform 105, the mechanical torque load of the motor is zero or near zero. When the mechanical torque load is zero or near zero, the back-EMF waveform 125 is phase-shifted by 90° compared to the coil current waveform 120.

In the illustrated example of FIG. 1, the second waveform 110 illustrates a phase-shift between the coil current waveform 120 and the back-EMF waveform 125 when the motor is partially loaded. For example, the second waveform 110 illustrates the phase-shift as the motor load approaches the torque capability of the motor. When the motor load approaches the torque capability of the motor, the back-EMF waveform 125 moves in phase with the coil current waveform 120.

In the illustrated example of FIG. 1, the third waveform 115 illustrates a phase-shift between the coil current waveform 120 and the back-EMF waveform 125 when the motor is fully loaded. For example, the third waveform 115 illustrates the phase-shift as when the load torque is equal to or at the torque capability of the motor. When the motor is fully loaded, the back-EMF waveform 125 is in phase with the coil current waveform 120.

In some examples, when the mechanical torque load increases beyond the fully-loaded condition, the rotor falls out of synchronization with the stator magnetic field, causing the motor to stall. Therefore, FIG. 1 illustrates that for an unloaded motor, back EMF is 90° phase-shifted from the motor current. As the load increases, the back EMF phase-shift decreases. Finally, as the load increases to the point where the load torque exceeds the full-loaded condition, the motor stalls and the back-EMF goes to zero. By detecting back EMF phase-shift between rising and falling current quadrants of the motor current, the sensorless stall detection methods can detect a motor overload stall condition or an end-of-line travel. However, if the current is not sinusoidal, then the phase-shift of the back EMF may not be accurate and, thus, the stall condition is not detected or is falsely detected.

As mentioned above, the sensorless stall detection solutions available do not detect stall reliably across wide range of operating parameters such as supply voltage, operating speed, and loading conditions. For example, if loading on a motor is increased, the motor will continue spinning with the same speed but the phase shift will get closer to zero creating a false stall. In another example, if supply voltage increases, the motor usually continues spinning with same speed but the phase shift increases and threshold may not be reliable. In some examples, if supply voltage drops, the phase shift goes closer to zero. In some examples, for operating speed, the phase shift reduces and can cause false stall detection.

Some embodiments relate to a protection circuit that implements a sensorless stall detection method that works reliably across any supply voltage, operating speed, and/or loading condition. Some embodiments measure the energy flowing into the motor to detect a stall condition. The energy flowing into the motor can be used to determine the flux generated in the motor, which indicates the state of the motor (stalled or running). The flux generated in the motor may be referred to as magnetic flux and is a quantity that specifies an amount of a magnetic field and may be represented by the symbol Φ. In some embodiments, the magnetic flux Φ is determined by measuring, not assuming, the current and voltage across the one or more coils of the motor, which may advantageously make stall detection more reliable than the aforementioned solutions.

In some embodiments, the current through and the voltage across the one or more coils of the motor can be used to determine active and reactive energy flowing into the motor as well as active loss and reactive loss of the motor. Active energy is equal to a real part of complex power and is the energy or power that the motor converts into useful mechanical work, such as turning the shaft, driving the load, etc. Active loss is the energy loss associated with active power consumption, such as heat generated due to a resistance of the windings or coils. Reactive energy is equal to an imaginary part of complex power that arises from an interaction of inductance and capacitance in the motor and is used to create and maintain the magnetic field. Reactive loss is the energy loss associated with reactive power due to an inductance of the windings or coils.

Such active and reactive energy, and associated power losses, can be used to calculate the magnetic flux @. Using active and reactive energy to determine the magnetic flux @ enables the motor controller to define a constant threshold value that can be used to determine when the motor has stalled. Other stall detection solutions for sensorless motors may have used two or more different thresholds to detect stall conditions. For example, other solutions may measure back EMF to detect a stall condition, and in one stall condition, the back EMF may be zero, while in a second stall condition, the back EMF may be a non-zero value. Some embodiments use a single threshold value that is indicative of a stall condition. In some examples, the protection circuit can detect the stall condition independent of the loading condition and operating state of the motor.

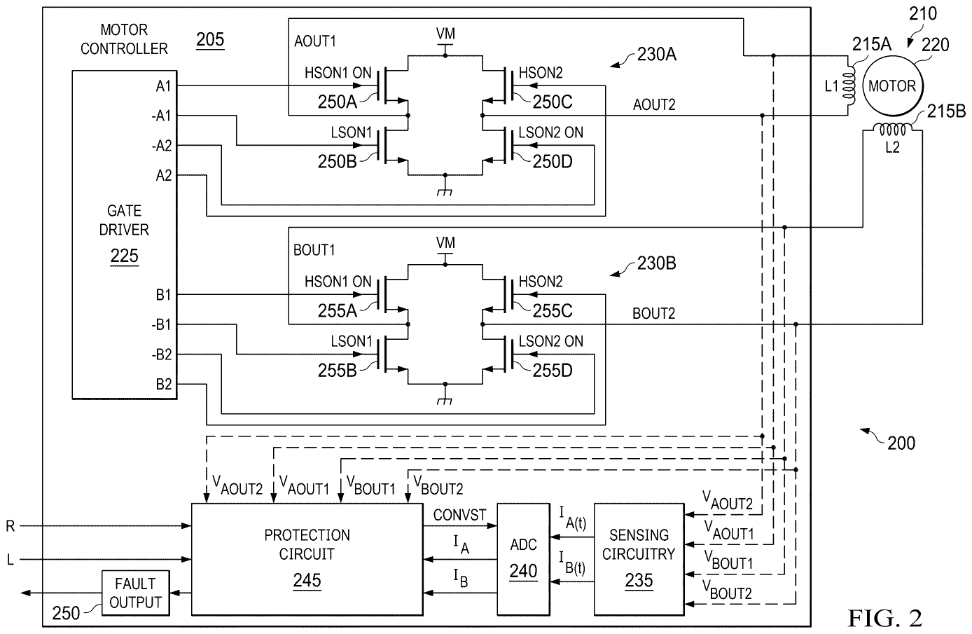

FIG. 2 is a block diagram of motor control system 200 that includes a motor controller 205 and a motor 210, according to an embodiment of the present disclosure. In some examples, the motor control system 200 is an electronic circuit.

Motor 210 includes a first coil 215A, a second coil 215B, and a rotor 220. In some examples, the first and second coils 215A, 215B are inductive windings that generate a rotating magnetic field which interacts with magnets of the rotor 220 to rotate the rotor 220. The motor controller 205 induces the rotating magnetic field across the first and second coils 215A, 215B. In this example, the motor 210 is a two-phase stepper motor.

The two-phase stepper motor 210 may operate by sequentially energizing and de-energizing two sets of coils (e.g., phases or inductive windings 215A, 215B) in a specific sequence. The sequential energizing and de-energizing creates a rotating magnetic field that the rotor 220 aligns with, causing the rotor 220 to rotate in precise steps. The step angle, or the amount the rotor 220 rotates per step, is determined by the design of the motor 210. Alternatively, the motor 210 may be any DC motor, such as a brushless motor, a brushed DC motor, etc. Although two inductive windings 215A, 215B are illustrated for the two-phase motor 210, the motor 210 may include any number of inductive windings or phases to rotate the rotor 220, such as a single inductive winding or three or more inductive windings. In some examples, the inductive windings 215A, 215B are referred to as “coils”.

In FIG. 2, the motor controller 205 is an integrated circuit (IC) that includes a gate driver 225, a first full bridge configuration 230A, a second full bridge configuration 230B, sensing circuitry 235, an analog-to-digital converter (ADC) 240, a protection circuit 245, and a fault output 251. In some embodiments, motor controller 205 may be implemented using a single IC that includes elements 225, 230A, 230B, 235, 240, 245, and 150. In other embodiments, motor controller 205 may be implemented using multiple discrete components, as opposed to being integrated in a single IC. Other implementations are also possible.

In some embodiments, gate driver 225 includes or is coupled to a gate driver controller (not shown) to generate or cause generation of the outputs of gate driver 225. In some embodiments, such gate driver controller is implemented as a generic or custom controller or processor coupled to a memory and is configured to execute instructions stored in such memory. In some embodiments, such gate driver controller is implemented with a field programmable gate array (FPGA). In some embodiments, such gate driver controller is implemented or includes synthesized logic. In some embodiments, such gate driver controller includes a state machine. Other implementations of such gate driver controller may also be possible.

In FIG. 2, the gate driver 225 drives the full bridge configurations 230A, 230B to generate a driving operating state of the motor 210. The first and second full bridge configurations 230A, 230B, also referred to as an “H-bridge”, are circuits of four switches that allow voltages to be applied across respective inductive windings 215A, 215B of the motor 210 in either direction in order to change a direction of current flow through the inductive windings 215A, 215B and, thus, reverse the rotation of the rotor 220. The gate driver 225 outputs logic signals that cause the first full bridge configuration 230A and/or the second full bridge configuration 230B to output voltages that put the motor 210 in a drive mode, in slow decay, or in fast decay. In some examples, the gate driver 225 generates pulse width modulation (PWM) signals that configure the driving operating state of the motor 210.

In FIG. 2, the first full bridge configuration 230A includes a first transistor 250A, a second transistor 250B, a third transistor 250C, and a fourth transistor 250D. The second full bridge configuration 230B includes a first transistor 255A, a second transistor 255B, a third transistor 255C, and a fourth transistor 255D. The gate driver 225 generates logic signals A1, A̅1̅, A2, A̅2̅ to drive the gates of transistors 250A-D and generates logic signals B1, B̅1̅, B2, B̅2̅ to drive the gates of transistors 255A-D. In some examples, the logic signals A1, A̅1̅, A2, A̅2̅ and B̅1̅, B1, B2, B̅2̅ are PWM signals. The inductive winding 215A is coupled across a junction (AOUT1 node) of transistors 250A and 250B and a junction (AOUT2) of transistors 250C and 250D. The inductive winding 215B is coupled across a junction (BOUT1 node) of transistors 255A and 255B and a junction (BOUT2) of transistors 255C and 255D. The current flow through the inductive windings 215A, 215B is based on AOUT1, AOUT2, BOUT1, and BOUT2, respectively. Therefore, the driving operating state is based on values of AOUT1, AOUT2, BOUT1, and BOUT2. For example, the current flow through the inductive windings 215A, 215B determines the rotation of the rotor 220. The values of AOUT1, AOUT2, BOUT1, and BOUT2 are determined based on the logic signals A1, A̅1̅, A2, A̅2̅, B1, B̅1̅, B2, B̅2̅, which either turn on or turn off transistors 250A-D and transistors 255A-D to generate specific AOUT and BOUT values. As such, the signal on the AOUT1 node is based on the on/off state of the transistors 250A and 250B, and the signal on the AOUT2 node is based on the on/off state of the transistors 250C and 250D. Similarly, the signal on the BOUT1 node is based on the on/off state of the transistors 255A and 255B, and the signal on the BOUT2 node is based on the on/off state of the transistors 255C and 255B. In some examples, although the logic signals are referred to as complementary logic signals (e.g., A1, A̅1̅, or A2, A̅2̅, etc.), the gate driver 225 may output zeros for all logic signals A1, A̅1̅, A2, A̅2̅, B1, B̅1̅, B2, B̅2̅. For example, the gate driver 225 outputs zeros to turn off the transistors 250A-D and transistors 255A-D.

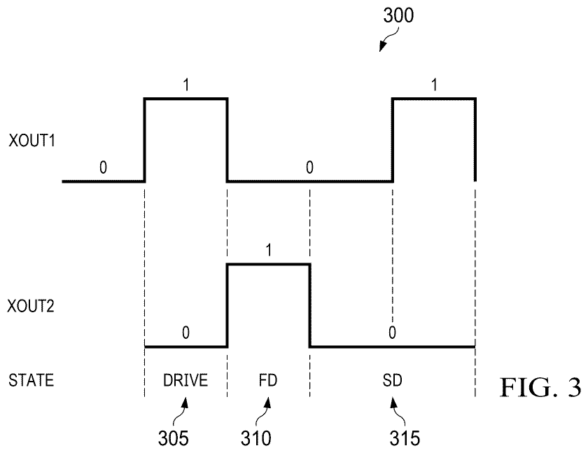

For example, turning briefly to FIG. 3, an example timing diagram 300 depicts example voltage states 305, 310, and 315 of a full bridge configuration, such as the full bridge configuration 230A or the full bridge configuration 230B, according to an embodiment of the present disclosure. The voltage states 305, 310, and 315 determine the driving operating state of the motor 210. In the timing diagram 300, “XOUT1” refers to a voltage state of the AOUT1 node and/or a voltage state of the BOUT1 node, and “XOUT2” refers to the voltage state of the AOUT2 node and/or the voltage state of the BOUT2 node. In FIG. 3, the voltage state of XOUT1 and the voltage state of XOUT2 is represented as a logic high (1) or a logic low (0). However, the voltage of XOUT1 and XOUT2 can be any voltage value, such as 12V, 28V, 0V, −12V,-28V, etc. For example, the voltage that XOUT1 and XOUT2 correspond to depends on the VM voltage applied to a supply voltage terminal of the full bridge configuration 230A and the full bridge configuration 230B.

In FIG. 3, the first voltage state 305 is a positive voltage state that causes the motor 210 to operate in a forward drive. In the positive voltage state 305, XOUT1 is high and XOUT2 is low. In some examples, XOUT1 is high when transistor 250A is turned on and transistor 250B is turned off because AOUT1 is equal to supply voltage (VM), or when transistor 255A is turned on and transistor 255B is turned off because BOUT1 is equal to supply voltage (VM). In some examples, XOUT2 is low when transistor 250D is turned on and transistor 250C is turned off because AOUT2 is pulled to ground, or when transistor 255D is turned on and transistor 255C is turned off because BOUT2 is pulled to ground. The first voltage state 305 is a positive voltage state because a positive voltage is applied across the inductive winding 215A or inductive winding 215B. The positive voltage induces a positive current to flow through the inductive winding (215A, 215B), which rotates the rotor 220 in a forward motion.

In FIG. 3, the second voltage state 310 is a negative voltage state that causes the motor 210 to operate in a reverse drive, also referred to as “fast decay”. In the negative voltage state 310, XOUT1 is low and XOUT2 is high. In some examples, XOUT1 is low when transistor 250A is turned off and transistor 250B is turned on because AOUT1 is pulled to ground, or when transistor 255A is turned off and transistor 255B is turned on because BOUT1 is pulled to ground. In some examples, XOUT2 is high when transistor 250C is turned on and transistor 250D is turned off because AOUT2 is equal to supply voltage, or when transistor 255C is turned on and transistor 255D is turned off because BOUT2 is equal to supply voltage. The second voltage state 310 is a negative voltage state because a negative or reverse voltage is applied across the inductive winding 215A or inductive winding 215B. The negative voltage induces a current to flow in an opposite direction, relative to the positive current flow, through the inductive winding (215A, 215B), which rotates the rotor 220 in a reverse motion. For example, by driving transistor 250B and transistor 250C (or transistors 255B and 255C) into conduction, supply voltage (VM) is applied across the inductive winding 215A (or inductive winding 215B), but with the opposite polarity, (e.g., a polarity that encourages the inductive current to decay more quickly).

In FIG. 3, the third voltage state 315 is a zero voltage state that causes the motor 210 to operate in slow decay mode. In the zero voltage state 315, XOUT1 and XOUT2 are both low because the low-side transistors (250B and 250D, or 255B and 255D) are both turned on while the high side transistors (250A and 250C, or 255A and 255C) are both turned off. The third voltage state 315 is a zero voltage state because zero voltage is applied across the inductive winding 215A or inductive winding 215B. The zero voltage causes the current through the inductive winding (215A, 215B) to decrease to zero. In this case, there is no applied voltage forcing the current to rapidly discharge, rather, current is dissipated as heat as the current flows through a resistance of the inductive winding (215A, 215B) and an on-state resistance of the two low-side transistors (250B and 250D, or 255B and 255D). The rotor 220 therefore stops rotating.

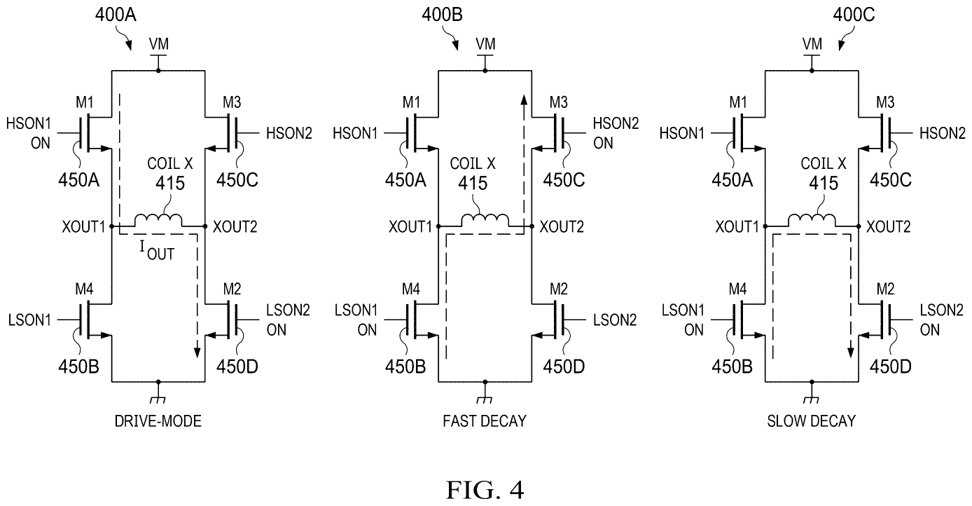

Turning to FIG. 4, a schematic diagram of example full bridge circuits 400A, 400B, and 400C, according to an embodiment of the present disclosure. The full bridge circuits 400A-400C are illustrated to depict the how transistors of the example full bridge circuits 400A-400C configure the three voltage states 305, 310, 315 of FIG. 3 and, thus, the driving operating state of the motor 210 of FIG. 2. The full bridge circuits 400A-400C include a first transistor 450A, a second transistor 450B, a third transistor 450C, a fourth transistor 450D, and an inductive winding 415. In some examples, the full bridge circuits 400A-400C represent the full bridge configuration 230A of FIG. 2. As such, transistors 450A-450D represent transistors 250A-250D. Alternatively, in some examples, the full bridge circuits 400A-400C represent the full bridge configuration 230B of FIG. 2. As such, transistors 450A-450D represent transistors 255A-255D.

As described above in connection with FIG. 3, the full bridge circuit 400A operates in a positive voltage state (e.g., voltage state 305 of FIG. 3) when the transistors 450A and 450D are on, and transistors 450B and 450D are off. The on states of transistors 450A and 450D cause a positive voltage to be applied across the inductive winding 415, forcing current to flow in a positive direction and rotating the rotor (not shown) in a forward drive.

The full bridge circuit 400B operates in a negative voltage state (e.g., voltage state 315 of FIG. 3) when the transistors 450B and 450C are on, and transistors 450A and 450D are off. The on states of the transistors 450B and 450C cause a negative voltage to be applied across the inductive winding 415, forcing current to flow in reverse direction and rotating the rotor (not shown) in the reverse direction.

The full bridge circuit 400C operates in a zero voltage state (e.g., voltage state 310 of FIG. 3) when the transistors 450B and 450D are on, and transistors 450A and 450C are off. The on states of the low-side transistors 450B and 450D cause zero voltage to be applied across the inductive winding 415, forcing current dissipate rather than flow through the inductive winding, causing the rotor (not shown) to slowly stop rotating.

In the example of FIGS. 2 and 4, the transistors 250A-250D, transistors 255A-255D, and transistors 450A-450D are n-channel metal-oxide semiconductor field-effect transistors (MOSFETs). Alternatively, the transistors 250A-250D, transistors 255A-255D, and transistors 450A-450D may be n-channel field-effect transistors (FETs), n-channel insulated-gate bipolar transistors (IGBTs), n-channel junction field effect transistors (JFETs), NPN bipolar junction transistors (BJTs) or, with slight modifications, p-type equivalent devices. The transistors 250A-250D, transistors 255A-255D, and transistors 450A-450D may be depletion mode devices, drain-extended devices, enhancement mode devices, natural transistors or other type of device structure transistors. Furthermore, the transistors 250A-250D, transistors 255A-255D, and transistors 450A-450D may be implemented in/over a silicon substrate (Si), a silicon carbide substrate (SiC), a gallium nitride substrate (GaN) or a gallium arsenide substrate (GaAs).

Returning to the motor control system 200 of FIG. 2, the sensing circuitry 235 senses currents (I_{A} and I_{B}) across the inductive windings 215A and 215B based on the voltages of AOUT1, AOUT2, BOUT1, and BOUT2 (V_{AOUT1}, V_{AOUT2}, V_{BOUT1}, V_{BOUT2}). In some examples, the sensing circuitry 235 is implemented by one or more current sense amplifiers and one or more resistors. In some examples, a resistor is placed in series with the inductive windings 215A, 215B to sense currents (I_{A} and I_{B}). In some examples, the sensing circuitry 235 may be implemented by one or more shunt resistors. The sensing circuitry 235 can include any devices that facilitate measuring the current flow through the inductive windings 215A, 215B. The sensing circuitry 235 receives voltages V_{AOUT1}, V_{AOUT2}, V_{BOUT1}, V_{BOUT2} from the outputs of the full bridge configurations 230A and 230B and provides current signals I_{A(t)} and I_{B(t)} to the analog-to-digital converter (ADC) 240. The current signals I_{A(t)} and I_{B(t)} represent the current measured at time t.

The motor control system 200 of FIG. 2 includes the ADC 240 to convert the current signals I_{A(t)} and I_{B(t)} to discrete numerical values representing the current at time t. The ADC 240 converts I_{A(t)} and I_{B(t)} to digital currents I_{A} and I_{B}. In some examples, the ADC 240 converts the currents I_{A(t)} and I_{B(t)} in response to a conversion start signal (CONVST) provided by the protection circuit 245. For example, the ADC 240 may convert current signal I_{A(t)} for one electrical cycle (e.g., time 0-time t) and/or current signal I_{B(t)} for one electrical cycle when the protection circuit 245 generates the CONVST signal. The ADC 240 provides digital currents digital currents I_{A} and I_{B} to the protection circuit 245 for further processing and detecting of a stall condition.

The motor control system 200 of FIG. 2 includes the protection circuit 245 to monitor the state of the motor 210. The motor 210 may be in a running state or in a stall state. If the motor 210 is stalled, protective actions are to be taken, such as shutting off, reducing, or adjusting power provided to the motor 210. To monitor the state of the motor 210, the protection circuit 245 measures active energy (W_{S}) and reactive energy (x_{S}) flowing into the motor 210 based on the currents I_{A} and I_{B}, the voltages V_{AOUT1}, V_{AOUT2}, V_{BOUT1}, V_{BOUT2}. The protection circuit 245 uses the active energy (W_{S}), reactive energy (x_{S}), and the resistance (R) and self-inductance (L) values of the motor 210 to determine the state of the motor 210. For example, the protection circuit 245 uses the active energy (W_{S}), reactive energy (x_{S}), and the resistance (R) and self-inductance (L) values of the motor 210 to determine magnetic flux Φ of the motor 210, which can be used to compute a magnitude of motor flux of the motor 210, which is then compared to a threshold to determine the state of the motor 210.

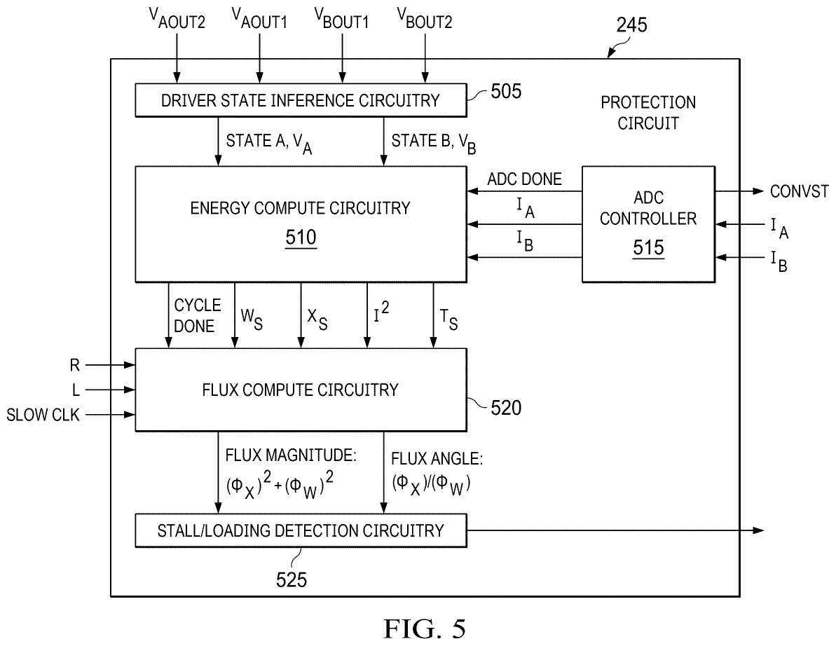

In some examples, the protection circuit 245 monitors loading of the motor 210 to detect a stall condition. For example, the protection circuit 245 generates a flux angle, also referred to as torque angle, based on the magnetic flux Φ. The flux angle is the angular displacement between a flux of the rotor 220 and a flux of the stator 215A, 215B. The flux angle or torque angle can indicate a loading condition of the motor 210. For example, a large flux angle (near 90 degrees) indicates a light load condition while a small flux angle (less than 90 degrees) is indicative of a heavy load or potential overload condition. In some examples, the loading condition of the motor 210 can also be used to detect a stall. As further illustrated and described, e.g., in FIG. 1, when the mechanical torque load or torque angle increases beyond the fully-loaded condition (e.g., 90 degrees), the rotor 220 falls out of synchronization with the magnetic field of the stator 215A, 215B, causing the motor 210 to stall. Therefore, the protection circuit 245 may monitor loading of the motor 210 to detect the stall condition. The protection circuit 245 is described in further detail below in connection with FIG. 5.

The motor control system 200 of FIG. 2 includes the fault output 251 to generate a signal that indicates when the motor 210 is in a stall condition. In some examples, the fault output 251 generates a voltage that is provided to a fault pin (not shown) of the motor controller 205 and indicative of the state of the motor 210. For example, the fault output 251 generates a high voltage when the motor 210 is running, and pulls the fault pin to ground when a fault is detected. In some examples, a fault is detected when the protection circuit 245 indicates that the motor 210 is stalled.

FIG. 5 is a block diagram of an example implementation of the protection circuit 245 of FIG. 2, according to an embodiment of the present disclosure. The protection circuit 245 of FIG. 5 may be instantiated (e.g., creating an instance of, bring into being for any length of time, materialize, implement, etc.) by programmable circuitry such as a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Also or alternatively, the protection circuit 245 of FIG. 5 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 5 may, thus, be instantiated at the same or different times. Some or all of the circuitry of FIG. 5 may be instantiated, for example, in one or more threads executing concurrently on hardware or in series on hardware. Moreover, in some examples, some or all of the circuitry of FIG. 5 may be implemented by microprocessor circuitry executing instructions or FPGA circuitry performing operations to implement one or more virtual machines or containers.

In some embodiments, protection circuit 245 and the gate driver controller may be implemented as a single controller. In some embodiments, the gate driver controller and protection circuit 245 may be implemented as separate controllers.

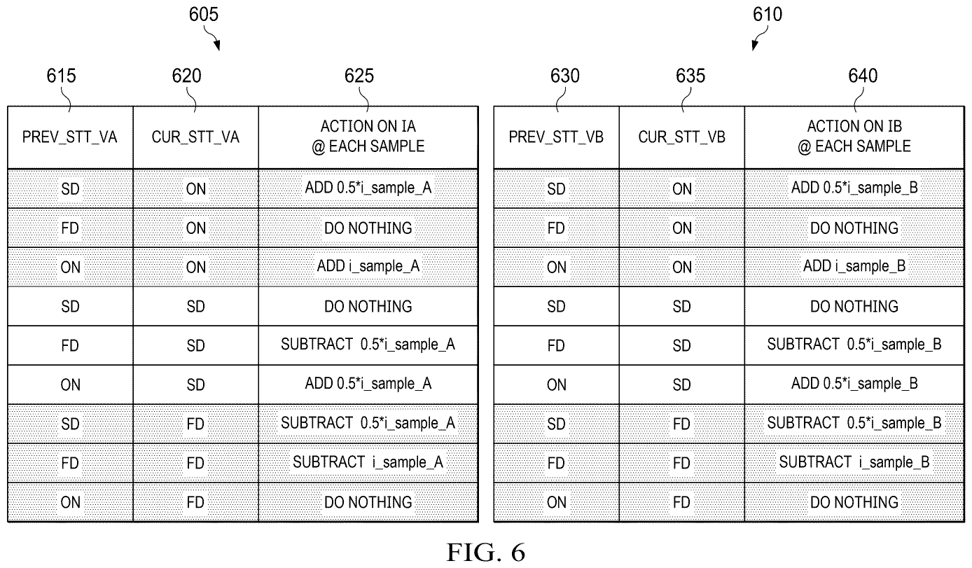

In some embodiments, the protection circuit 245 of FIG. 5 includes driver state inference circuitry 505, energy compute circuitry 510, an ADC controller 515, flux compute circuitry 520, and stall/loading detection circuitry 525. In some examples, the driver state inference circuitry 505, the energy compute circuitry 510, the ADC controller 515, the flux compute circuitry 520, and the stall/loading detection circuitry 525 may be instantiated by programmable circuitry executing instructions to perform operations such as those represented by the flowcharts of FIGS. 6A and 6B.

In some embodiments, the protection circuit 245 of FIG. 5 includes the driver state inference circuitry 505 to determine a first driving operating state (STATE A) and a second driving operating state (STATE B) of the motor 210 based on voltages V_{AOUT1}, V_{AOUT2}, V_{BOUT1}, V_{BOUT2}. In some examples, the driver state inference circuitry 505 is to determine a first phase voltage (V_{A}) based on voltages V_{AOUT1} and V_{AOUT2} and a second phase voltage (V_{B}) based on voltages V_{BOUT1} and V_{BOUT2}. To determine the driving operating state (STATE A), the driver state inference circuitry 505 may implement a lookup table that provides information about the driving operating state (e.g., drive mode, fast decay, slow decay) based on different combinations of voltages V_{AOUT1} and V_{AOUT2} and voltages V_{BOUT1} and V_{BOUT2}. For example, when V_{AOUT1} is high (e.g., 12V, 28V, etc.) and V_{AOUT2} is low (e.g., 0V), the driver state inference circuitry 505 can look up that combination in the lookup table to determine that the first driving operating state is in a drive mode (e.g., STATE A=drive mode). In some examples, when V_{BOUT1} is low and V_{BOUT2} is high, the driver state interface circuitry 505 may look that combination up in the lookup table to determine that the second driving operating state is in slow decay (e.g., STATE B=SD). To determine the phase voltages (V_{A} and V_{B}), the driver state inference circuitry 505 may perform a calculation with V_{AOUT1} and V_{AOUT2} and with V_{BOUT1} and V_{BOUT2}. For example, the driver state inference circuitry 505 may subtract V_{AOUT2} from V_{AOUT2} to obtain phase voltage V_{A}, and may subtract V_{BOUT2} from V_{BOUT1} to obtain phase voltage V_{B}.

In some embodiments, the driver state inference circuitry 505 provides the driving operating states (e.g., STATE A and STATE B) and the phase voltages (V_{A} and V_{B}) to the energy compute circuitry 510. In some examples, the driver state inference circuitry 505 may provide a time or time stamp associated with the driving operating states. For example, at a first time, STATE A and STATE B may be in drive mode but at a second time after the first time, STATE A and STATE B may be in a fast decay state. In some examples, the driver state inference circuitry 505 provides the phase voltages to the energy compute circuitry 510 over a period of time.

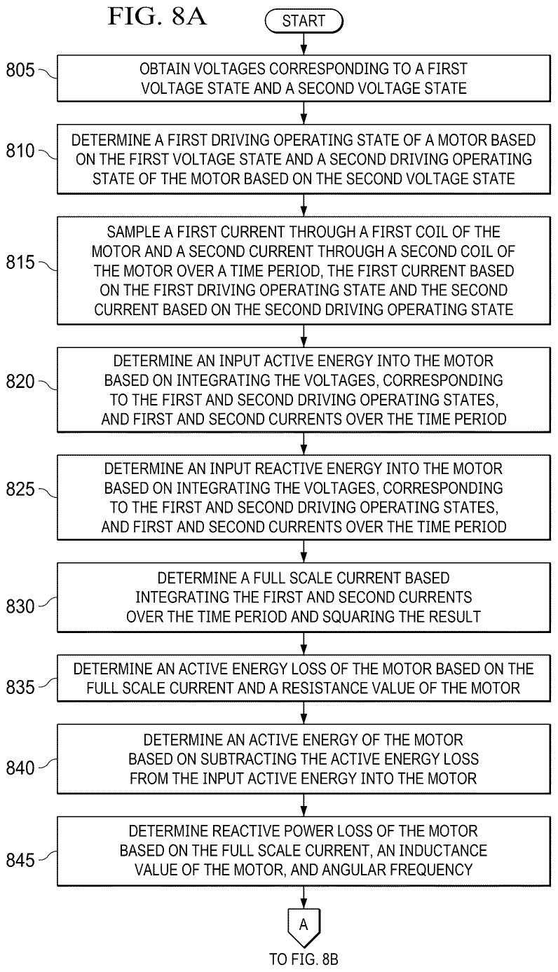

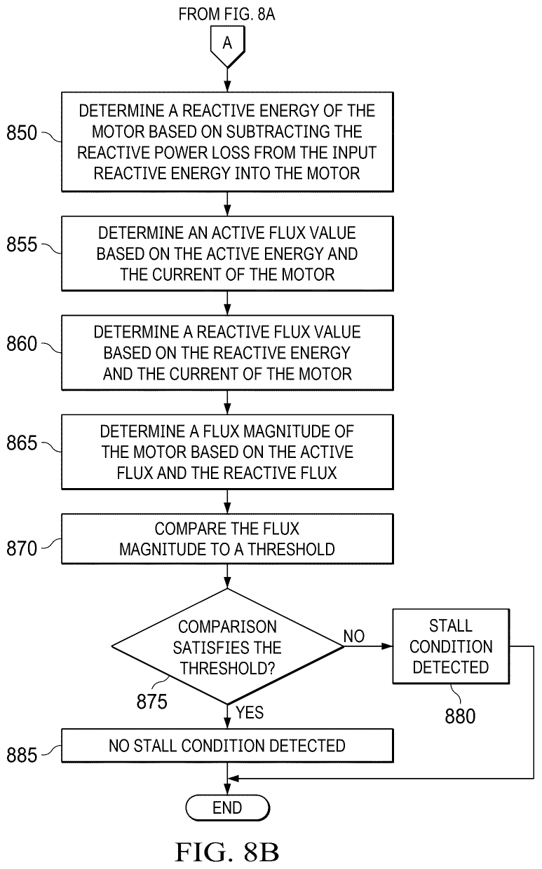

In some examples, the protection circuit 245 is capable of determining a driving state of the motor, e.g., by using driver state inference circuitry 505. In some examples, the driver state inference circuitry 505 may be instantiated by programmable circuitry executing machine executable instructions such as those implemented by at least blocks 805 and 810 of FIG. 8A. In some examples, the driver state inference circuitry 505 may be instantiated by hardware logic circuitry, which may be implemented by an ASIC, XPU, or FPGA circuitry that are structured to perform operations corresponding to the machine-readable instructions. Also or alternatively, the driver state inference circuitry 505 may be instantiated by any other combination of hardware, software, or firmware. For example, the driver state inference circuitry 505 may be implemented by at least one or more hardware circuits (e.g., processor circuitry, discrete or integrated analog or digital circuitry, an FPGA, an ASIC, an XPU, a comparator, an operational-amplifier (op-amp), a logic circuit, etc.) configured or structured to execute some or all of the machine-readable instructions or to perform some or all of the operations corresponding to the machine-readable instructions without executing software or firmware, but other structures are likewise appropriate.

In some embodiments, the protection circuit 245 of FIG. 5 includes the energy compute circuitry 510 to determine the energy flowing into the motor 210. The energy flowing into the motor 210 is computed because energy flowing into the motor 210 is dependent on the state of the motor 210 and, thus, indicative of a running or stalled condition. For example, the energy flowing into the motor 210 can be determined by Equation 1 below.

$$\int vidt = \int ( {i}^{2} R + {ω}_{e} {Li}^{2} + Ei ) dt \qquad Equation 1$$

In Equation 1, v represents the phase voltage of the motor 210, i represents the current of the motor 210, R represents the resistance of the motor 210, L represents the inductance of the motor 210, we represents the electrical angular velocity of the motor 210, and E refers to the back EMF of the motor (Wₘₒₜₒᵣ) 210. In Equation 1, the integral of voltage (v) and current (i) (or otherwise, the integral of power), gives energy into the motor (Wₘ), typically measured in joules (J). In Equation 1, the integral of the product of i²R represents resistive power losses of the motor 210 (or, otherwise, the energy dissipated as heat due to resistance of the motor 210). In Equation 1, and the integral of the product of ωₑLi² represents the energy stored in the inductive component of the motor 210. As described above, the motor 210 may have more than one phase. As such, the energy flowing into the motor 210 can be determined by measuring all phase voltages and currents of the motor 210.

As depicted by Equation 1 above, the energy going into the system is partly going to the motor 210, partly going to the inductive windings 215A, 215B, and will be partly lost to the resistive losses. Over one time period, when the motor 210 is running, the electrical angular velocity we increases (e.g., the angular seed of the rotating magnetic field), the torque decreases due to the increase in we, resistive losses (Wₗₒₛₛ) decrease, the inductive losses (W_{ind}) are near zero, and the energy of the motor (Wₘₒₜₒᵣ) is equal to is a function of the electrical phase angle (φₑ) between the current (I) and back-EMF of the motor 210 (E). At stall, the energy into the motor (Wₘ) is equal to the resistive power losses (Wₗₒₛₛ).

In some embodiments, the energy compute circuitry 510 determines an active energy (W_{S}) flowing into the motor 210 and a reactive energy (x_{S}) flowing into the motor 210 because there is energy in a resistive load (e.g., copper and iron losses or resistive losses) and energy in a reactive load (e.g., the inductive load). The energy compute circuitry 510 determines the active energy W_{S} and the reactive energy x_{S} flowing into the motor 210 based on phase voltages (v_{A}, v_{B}) of the motor 210 and the currents (i_{A}, i_{B}) of the motor. For example, the energy compute circuitry 510 determines the active energy into the motor 210 based on Equation 2 below, and determines the reactive energy into the motor 210 based on Equation 3 below.

$${W}_{S} = {\int }_{0}^{{T}_{S}} ( {i}_{A} {v}_{A} + {i}_{B} {v}_{B} ) dt \qquad Equation 2$$

In Equation 2, W_{S} represents the active energy into the motor, T_{S} represents the time period of one electrical cycle, i_{A} represents the current through the first inductive winding 215A induced by the first phase voltage v_{A}, i_{B} represents the current through the second inductive winding 215B induced by the second phase voltage v_{B}.

$${X}_{S} = {\int }_{0}^{{T}_{s}} ( {i}_{A} {v}_{B} - {i}_{B} {v}_{A} ) dt \qquad Equation 3$$

In Equation 3, x_{S} represents the reactive energy into the motor 210, T_{S} represents the time period of one electrical cycle, is represents the current through the first inductive winding 215A induced by the first phase voltage v_{A}, i_{B} represents the current through the second inductive winding 215B induced by the second phase voltage v_{B}.

In some embodiments, the energy compute circuitry 510 may determine the full scale current of the motor 210 over the time period of one electrical cycle. The full scale current of the motor 210 can be used to determine resistive and inductive power losses of the motor 210. As used herein, resistive power loss may be referred to as “active energy loss” and inductive power loss may be referred to as “reactive energy loss.” In some examples, the full scale current of the motor 210 represents the top of a sinusoidal current waveform when the gate driver 225 is micro stepping the motor 210 (e.g., moving the motor 210 in small increments). In some examples, the full scale current of the motor 210 represents the root-mean-square (RMS) current of a square wave current waveform when the gate driver 225 rotates the motor 210 in full steps. The “top” of a sinusoidal current waveform refers to the highest point or crest of the wave during the electrical cycle and differs from the “peak” of the waveform, where the peak of the waveform refers to the overall maximum amplitude, which is the greatest positive or negative value the wave reaches. The energy compute circuitry 510 determines the full scale current of the motor 210 based on Equation 4 below:

$${I}^{2} = \frac{1}{Ts} {\int }_{0}^{{T}_{S}} ( {i}_{A}^{2} + {i}_{B}^{2} ) dt \qquad Equation 4$$

In Equation 4, I² represents the full scale current of the motor 210, i_{A} represents the current through the first inductive winding 215A induced by the first phase voltage v_{A}, i_{B} represents the current through the second inductive winding 215B induced by the second phase voltage v_{B}, and T_{S} represents the time period of one electrical cycle (e.g., the sampling period). In some examples, the energy compute circuitry 510 can multiply the integral of i_{A}² and i_{B}² by the sampling frequency (F_{S}). The energy compute circuitry 510 integrates the sampled currents i_{A} and i_{B} over time to obtain the full scale current.

In some examples, the energy compute circuitry 510 uses approximation to compute the active energy into the motor 210 (W_{S}), the reactive energy into the motor 210 (x_{S}), and the full scale current of the motor 210 (I²). For example, the energy compute circuitry 510 implements the trapezoidal rule to compute the active energy, reactive energy, and full scale current. The trapezoidal rule approximates the definite integral of a function (e.g., Equation 2, 3, 4) by dividing the area under the curve into a series of trapezoids and summing their areas. For a function ƒ(t) integrated from a to b, with n equally spaced intervals of width h=(b−a)/n, the trapezoidal rule is illustrated in Equation 5 below:

$${\int }_{b}^{a} f ( x ) dt \approx \frac{h}{2} [ f ( {x}_{0} ) + 2 f ( {x}_{1} ) + 2 f ( {x}_{2} ) + … + 2 f ( {x}_{n - 1} ) + f ( {x}_{n} ) ] \qquad Equation 5$$

In Equation 5, ƒ(x) represents any of Equations 2, 3, or 4 above, x₀=a, x₁=a+h, x₂=a+2 h, . . . , and xₙ=b. Equation 5 can be applied to approximate Equations 2, 3, and 4 above by sampling the instantaneous currents (i_{A} and i_{B}) and phase voltages (v_{A} and v_{B}) over a time period of one electrical cycle (T_{S}). In some examples, the energy compute circuitry 510 samples n currents i_{A} and i_{B} and n phase voltages v_{A} and v_{B} at times x₀, x₂, x₂, . . . , xₙ, where to =0 and xₙ=T_{S}, where the sampling interval is h=T_{S}/n. Equation 5 is an example of just one approximation function that can be used to approximate Equations 2, 3, and 4 above. The energy compute circuitry 510 is not limited to approximating Equations 2, 3, and 4 using Equation 5 (the trapezoidal rule).

In some embodiments, the energy compute circuitry 510 samples the phase voltages V_{A} and v_{B} from the driver state inference circuitry 505. As described above, the first phase voltage v_{A} can be determined by subtracting V_{AOUT2} from V_{AOUT1} (v_{A}=V_{AOUT1}−V_{AOUT2}), and the second phase voltage v_{B} can be determined by subtracting V_{BOUT2} from V_{BOUT1} (v_{B}=V_{BOUT1}−V_{BOUT2}).

In some embodiments, the energy compute circuitry 510 receives sampled currents i_{A} and i_{B} from the ADC controller 515. For example, the energy compute circuitry 510 obtains an ADC DONE signal from the ADC controller 515 when n first currents i_{A} and n second currents i_{B} are sampled by the ADC controller 515.

In some embodiments, the energy compute circuitry 510 utilizes the current samples and phase voltage samples to compute the active energy into the motor 210, the reactive energy into the motor 210, and the full scale current of the motor 210. For example, to determine the active energy (W_{S}) into the motor 210, the energy compute circuitry 510 determines the active power at each sample point t₀-tₙ by obtaining a product of v_{A} and is and v_{B} and is at each sample point and then a sum of the products (e.g., i_{A}v_{A}+i_{B}v_{B}). Similarly, to determine the reactive energy (X_{S}) into the motor 210, the energy compute circuitry 510 determines the reactive power at each sample point t₀-tₙ by obtaining a product of v_{B} and i_{A} and v_{A} and i_{B} at each sample point and then a difference of the products (e.g., i_{A}v_{B}−i_{B}v_{A}).

In some examples, however, the energy compute circuitry 510 does not utilize the full sampled currents at each sample point when determining active and reactive energy into the motor 210. The energy compute circuitry 510 adjusts a value of the first current i_{A} and a value of the second current i_{B} based on the driving operating state of the motor 210 at the sample point. For example, energy compute circuitry 510 adjusts a value of the first current is based on comparing a current driving state of the first motor phase (e.g., STATE A at time tₙ) with a previous driving state of the first motor phase (e.g., STATE A at time tₙ₋₁) and adjusts a value of the second current is based on comparing a current driving state of the second motor phase (e.g., STATE B at time tₙ) with a previous driving state of the first motor phase (e.g., STATE A at time tₙ₋₁).

For example, turning briefly to FIG. 6, an example first table 605 and second table 610 are illustrated, according to an embodiment of the present disclosure. The first table 605 and the second table 610 depict an action the energy compute circuitry 510 takes on the first current i_{A} and takes on the second current is based on a driving operating state of the first motor phase A and the driving operating state of the second motor phase B. In FIG. 6, the first table 605 includes a first column 615, a second column 620, and a third column 625. In FIG. 6, the second table 610 includes a first column 630, a second column 635, and a third column 640.

The first column 615 represents a previous driving operating state of the first motor phase (PREV_STT_V_{A}). The second column 620 represents a current driving operating state of the first motor phase (CUR_STT_V_{A}). The third column 625 represents an action taken on the first current is at each sample point based on the driving operating states in columns 615 and 620. The first and second columns 615 and 620 include the three driving operating states illustrated in FIGS. 3 and 4: slow decay (SD), driving mode (ON), and fast decay (FD).

The second table 610 is substantially the same as the first table 605, where the first column 630 represents a previous driving operating state of the second motor phase (PREV_STT_V_{B}), the second column 635 represents a current driving operating state of the second motor phase (CUR_STT_V_{B}), and the third column 640 represents an action taken on the second current i_{B} at each sample point based on the driving operating states in columns 630 and 635.

As shown in the first table 605, the energy compute circuitry 510 is to add half of the sample of the first current is to an accumulated current (i_{A}_Acc) when the previous driving operating state slow decay and the current driving operating state is drive mode. The energy compute circuitry 510 is to add zero current (e.g., “do nothing”) to the accumulated current i_{A}_Acc when the previous driving operating state fast decay and the current driving operating state is drive mode. The energy compute circuitry 510 is to accumulate the entire sample of the first current i_{A} with the accumulated current value i_{A}_Acc when the previous driving operating state drive mode (ON) and the current driving operating state is drive mode (ON). The energy compute circuitry 510 is to accumulate zero current to the accumulated current value i_{A}_Acc when the previous driving operating state slow decay and the current driving operating state is slow decay. The energy compute circuitry 510 is to subtract half of the sample of the first current i_{A} from the accumulated current value i_{A}_Acc when the previous driving operating state fast decay and the current driving operating state is slow decay. The energy compute circuitry 510 is to add half of the sample of the first current i_{A} with the accumulated current value i_{A} Acc when the previous driving operating state drive mode and the current driving operating state is slow decay. The energy compute circuitry 510 is to subtract half of the sample of the first current is from the accumulated current value i_{A}_Acc when the previous driving operating state slow decay and the current driving operating state is fast decay. The energy compute circuitry 510 is to subtract the entire sample of the first current i_{A} from the accumulated current value i_{A}_Acc when the previous driving operating state fast decay and the current driving operating state is fast decay. Lastly, the energy compute circuitry 510 is to accumulate zero current with current value i_{A}_Acc when the previous driving operating state is drive mode and the current driving operating state is fast decay. At the end of the electrical cycle, the energy compute circuitry 510 scales the accumulated current i_{A}_Acc with the supply voltage value (VM), that is applied to the full bridge configuration 230A, to obtain an accumulated energy value (e.g., W_{S} or x_{S}) for the first motor phase A.

In some embodiments, the energy compute circuitry 510 performs the same actions on the second current i_{B} for the same combinations of previous driving operating states and current driving operating states of the second motor phase B.

In some embodiments, the energy compute circuitry 510 adjusts the value of the sampled current based on the driving operating state because the current is in sync with the phase voltage. For example, when the first phase voltage v_{A} goes from 0V to +12V, the first current i_{A} through the first inductive winding 215A is likely to increase, but not be at the full sampled current. In some embodiments, the energy compute circuitry 510 approximates that an accurate representation of the sampled current is half of what was sampled. Alternatively, when the first phase voltage v_{A} maintains+12V, the first current i_{A} flowing through the first inductive winding 215A is likely to be equivalent to the full sampled current.

Returning to FIG. 5, the energy compute circuitry 510 determines the current (I) of the motor 210 by squaring and adding the sampled the currents (i_{A} and i_{B}) at each sampling point and applying the trapezoidal rule to the squared samples. The energy compute circuitry 510 determines the full scale current of the motor 210 (I²) by dividing the current (I) by the time period (T_{S}) or by multiplying the current (I) by the sampling frequency (F_{S}). Similarly, the energy compute circuitry 510 determines the active power into the motor 210 by applying the trapezoidal rule to the active power samples (i_{A}v_{A}+i_{B}v_{B}). The energy compute circuitry 510 determines the reactive energy into the motor 210 by applying the trapezoidal rule to the reactive power samples (i_{A}v_{B}−i_{B}v_{A}). In some examples, the energy compute circuitry 510 may apply any type of approximation function to determine the full scale current, the active energy into the motor 210, and reactive energy into the motor 210. For example, the energy compute circuitry 510 may apply the Simpon's Rule or the Midpoint Rule to approximate the integral of the currents and phase voltages over the time period.

In some examples, the protection circuit 245 is capable of determining an input active energy flowing into the motor, an input reactive energy flowing into the motor, and a current flowing through the motor, e.g., using energy compute circuitry 510. In some examples, the energy compute circuitry 510 may be instantiated by programmable circuitry executing machine executable instructions such as those implemented by at least blocks 815, 820, 825, and 830 of FIG. 8A. In some examples, the energy compute circuitry 510 may be instantiated by hardware logic circuitry, which may be implemented by an ASIC, XPU, or FPGA circuitry that are structured to perform operations corresponding to the machine-readable instructions. Also or alternatively, the energy compute circuitry 510 may be instantiated by any other combination of hardware, software, or firmware. For example, the energy compute circuitry 510 may be implemented by at least one or more hardware circuits (e.g., processor circuitry, discrete or integrated analog or digital circuitry, an FPGA, an ASIC, an XPU, a comparator, an operational-amplifier (op-amp), a logic circuit, etc.) configured or structured to execute some or all of the machine-readable instructions or to perform some or all of the operations corresponding to the machine-readable instructions without executing software or firmware, but other structures are likewise appropriate.

In some embodiments, the protection circuit 245 includes the ADC controller 515 to control the conversion and sampling of the first and second currents i_{A}, i_{B}. The ADC controller 515 controls the sampling intervals (n) of the currents i_{A}, i_{B} during the sampling period T_{S}. In some examples, the ADC controller 515 sends a conversion start signal (CONVST) to the ADC 240 (not shown) at each sampling time x₀, x₁, x₂, . . . , xₙ to instruct the ADC 240 to convert the currents from the sensing circuitry 235 to digital values and provide to the ADC controller 515.

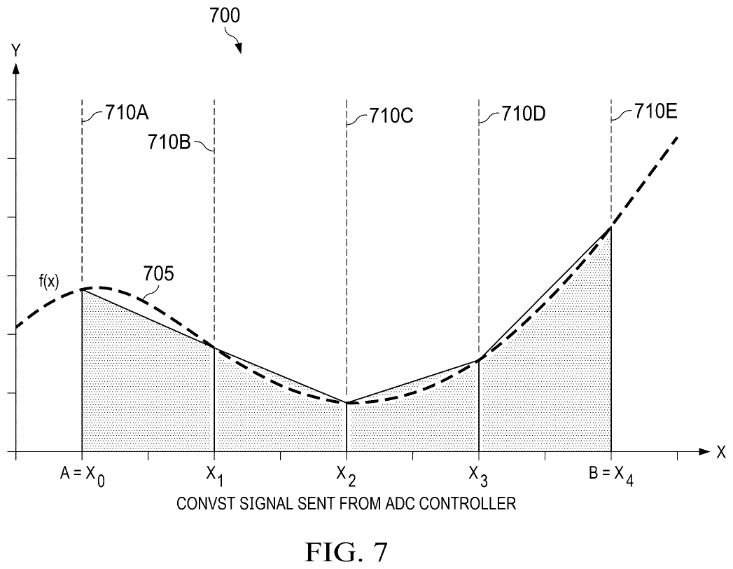

For example, turning briefly to FIG. 7, an example graph 700 of a function ƒ(x) 705 is illustrated, according to an embodiment of the present disclosure. The x-axis of the graph 700 depicts the sampling times x₀, x₁, x₂, x₃, and x₄ and the y-axis of the graph represents the value of the power (W) or current (A), depending on which function (e.g., Equation 2, 3, or 4) is being applied. In some examples, the graph 700 illustrates how the energy compute circuitry 510 approximates the value of a definite integral by using trapezoids. For example, the area under the ƒ(x) curve 705 is approximated by trapezoids. In some examples, the ƒ(x) curve 705 represents the reactive energy (X_{S}) into the motor 210, the active energy (W_{S}) into the motor 210, or the current (I) of the motor 210. For example, the active energy (W_{S}) and the reactive energy (X_{S}) can be depicted as a power waveform, where every point on the power waveform represents an instantaneous power measurement of the motor 210. Similarly, the current (I) of the motor 210 can be depicted as a current waveform, where every point on the current waveform represents an instantaneous current flowing through a coil of the motor 210.

In some embodiments, the graph 700 includes conversion start signal arrows 710A-E. The ADC controller 515 sends the conversion start signals to the ADC 240 at each sampling time to sample the currents, representative of the active energy, reactive energy, and full scale current, at specified intervals along the ƒ(x) curve 705. For example, the ADC controller 515 sends a first CONVST signal 710A to the ADC 240 at time x₀ to obtain the instantaneous first current i_{A} and the instantaneous second current is at time x₀. The ADC controller 515 sends a second CONVST signal 710B to the ADC 240 at time x₁ to obtain the instantaneous first current i_{A} and the instantaneous second current i_{B} at time x₁. The ADC controller 515 continues sending CONVST signals to the ADC 240 until n instantaneous samples of the currents i_{A} and i_{B} have been obtained for the time period T_{S}.

Returning to FIG. 5, the ADC controller 515 sends an ADC DONE signal to the energy compute circuitry 510 to inform the energy compute circuitry 510 that all n instantaneous samples of the currents i_{A} and i_{B} have been obtained for the time period T_{S} and enable the energy compute circuitry 510 to compute the W_{S}, x_{S}, and I².

In some examples, the protection circuit 245 is capable of controlling the sampling intervals of the currents during the sampling period, e.g., using ADC controller circuitry 515. In some examples, the ADC controller circuitry 515 may be instantiated by programmable circuitry executing machine executable instructions such as those implemented by at least block 815 of FIG. 8A. In some examples, ADC controller circuitry 515 may be instantiated by hardware logic circuitry, which may be implemented by an ASIC, XPU, or FPGA circuitry that are structured to perform operations corresponding to the machine-readable instructions. Also or alternatively, the ADC controller circuitry 515 may be instantiated by any other combination of hardware, software, or firmware. For example, the ADC controller circuitry 515 may be implemented by at least one or more hardware circuits (e.g., processor circuitry, discrete or integrated analog or digital circuitry, an FPGA, an ASIC, an XPU, a comparator, an operational-amplifier (op-amp), a logic circuit, etc.) configured or structured to execute some or all of the machine-readable instructions or to perform some or all of the operations corresponding to the machine-readable instructions without executing software or firmware, but other structures are likewise appropriate.

In some embodiments, the protection circuit 245 includes the flux compute circuitry 520 to determine the flux magnitude and flux angle of the motor 210 for a sampling time period T_{S}. As used herein, the term “flux magnitude” may be used interchangeably with “magnitude of the motor flux” and the term “flux angle” may be used interchangeably with “load angle.” In some examples, to determine the flux magnitude of the motor 210, the flux compute circuitry 520 has to determine resistive and inductive power losses of the motor 210 based on a resistance value (R) of the motor 210, an inductance value (L) of the motor 210, and the angular frequency. In some examples, the inductance value of the motor 210 is a self-inductance value. In some examples, the flux compute circuitry 520 obtains a SLOW CLK signal to slow a clock speed of the flux compute circuitry 520. For example, the clock speed of the flux compute circuitry 520 is a divided down version of protection circuit 245 clock speed because the flux compute circuitry 520 would require excessive logic gates to meet the timing requirements of the protection circuit 245 clock speed. In some examples, the flux compute circuitry 520 obtains a CYCLE DONE signal from the energy compute circuitry 510 when the energy compute circuitry 510 completes a computation cycle of W_{S}, x_{S}, and I². In some examples, the CYCLE DONE signal enables the flux compute circuitry 520 to compute the flux magnitude and the flux angle.

To determine the flux magnitude of the motor 210, the flux compute circuitry 520 may determine the active flux Φ_{w} and reactive flux Φₓ of the motor 210. The flux compute circuitry 520 determines the active flux Φ_{w} by first computing the resistive power loss Wₗₒₛₛ of the motor 210. The flux compute circuitry 520 computes the resistive power loss Wₗₒₛₛ based on Equation 6 below.

$${W}_{loss} = {I}^{2} {RT}_{s} \qquad Equation 6$$

In Equation 6, I² is the full scale current of the motor 210, R is the resistance value of the motor 210, and T_{S} is the time period of one electrical cycle. In some examples, the resistance value (R) is provided to the protection circuit 245, e.g., by a user. In some examples, the user obtains the resistance value (R) from a datasheet. Alternatively, the user may configure the resistance value (R) based on a desired preference of the motor 210.

The flux compute circuitry 520 determines the active energy of the motor 210 (Wₘₒₜₒᵣ) by subtracting the resistive power loss Wₗₒₛₛ from the active energy into the motor 210 (W_{S}). For example, the flux compute circuitry 520 determines the active energy of the motor 210 (Wₘₒₜₒᵣ) based on Equation 7 below.

$${W}_{motor} = {W}_{s} - {W}_{loss} \qquad Equation 7$$

In Equation 7, W_{S} is the active energy into the motor 210, Wₗₒₛₛ is the resistive power loss of the motor 210, and Wₘₒₜₒᵣ is the active energy of the motor 210.

The flux compute circuitry 520 determines the active flux Φ_{w} based on dividing the active energy of the motor 210 (Wₘₒₜₒᵣ) by the current of the motor 210 (I). For example, the flux compute circuitry 520 determines the active flux Φ_{w} using Equation 8 below.

$${Φ}_{w} = \frac{{W}_{motor}}{I} \qquad Equation 8$$

The flux compute circuitry 520 determines the reactive flux Φₓ by first computing the inductive energy loss Xₗₒₛₛ of the motor 210. The flux compute circuitry 520 computes the inductive energy loss Xₗₒₛₛ based on Equation 9 below.

$${X}_{loss} = 2 π {I}^{2} {L}_{0} \qquad Equation 9$$

In Equation 9, I² is the full scale current, and L₀ is the inductance value of the motor 210. In some examples, the user obtains the inductance value (L) from a datasheet. The angular frequency (ω) is denoted as 21.

The flux compute circuitry 520 determines the reactive energy of the motor 210 (Xₘₒₜₒᵣ) by subtracting the inductive power loss Xₗₒₛₛ from the reactive energy into the motor 210 (X_{S}). For example, the flux compute circuitry 520 determines the reactive energy of the motor 210 (Xₘₒₜₒᵣ) based on Equation 10 below.

$${X}_{motor} = {X}_{S} - {X}_{loss} \qquad Equation 10$$

In Equation 10, x_{S} is the reactive energy into the motor 210, Xₗₒₛₛ is the inductive power loss of the motor 210, and Xₘₒₜₒᵣ is the reactive energy of the motor 210.

The flux compute circuitry 520 determines the reactive flux Φₓ based on dividing the reactive energy of the motor 210 (Xₘₒₜₒᵣ) by the current of the motor 210 (I). For example, the flux compute circuitry 520 determines the reactive flux Φₓ using Equation 11 below.

$${Φ}_{x} = \frac{{X}_{motor}}{I} \qquad Equation 11$$

The flux compute circuitry 520 can use the active flux Φₓ and the reactive flux Φ_{y} to determine the flux magnitude of the motor 210. For example, to determine the flux magnitude of the motor 210, the flux compute circuitry 520 implements Equation 12 below.

$${Φ}_{magnitude} = {( {Φ}_{{w}_{motor}} )}^{2} + {( {Φ}_{{x}_{motor}} )}^{2} \qquad Equation 12$$

In Equation 12, the flux compute circuitry 520 squares the active flux Φ_{w} and the reactive flux Φₓ. The flux compute circuitry 520 squares the two values in order to obtain a constant value. For example, when there is a light loading condition, the active component of flux (e.g., the active flux Φ_{w}) and/or the reactive component of flux (e.g., reactive flux Φₓ) may be small, but the motor 210 is still in a running condition. In order to identify a running condition versus a stall condition (e.g., where there is no flux), the two flux components are squared and added to identify whether there is actually zero flux or whether there is some flux generated and, thus, the motor 210 is running.

In some examples, the flux compute circuitry 520 can use the active flux Φ_{w} and the reactive flux Φₓ to determine the flux angle of the motor 210. For example, the flux compute circuitry 520 determines the flux angle of the motor 210 by implementing Equation 13 below.

$${Φ}_{angle} = \frac{Φ X}{Φ W} \qquad Equation 13$$

In Equation 13, the active flux Φ_{w} is divided by the reactive flux Φₓ to obtain some value representative of the loading condition of the motor 210. For example, when the motor 210 is in a running condition, the flux angle is equal to the tangent (tan) of the phase between current (I) and back-EMF. As described above in connection with FIG. 1, the phase between back-EMF and coil current is indicative of the mechanical torque load of the motor 210. In some examples, when the motor 210 is in a stall condition, the flux angle is indeterminate because both the active flux Φ_{w} and the reactive flux Φₓ will be zero.

In some examples, the protection circuit 245 is capable of determining a magnitude of flux of the motor, e.g., using flux compute circuitry 520. In some examples, the flux compute circuitry 520 may be instantiated by programmable executing machine executable instructions such as those implemented by at least blocks 835, 840, 845, 850, 855, 860, and 865 of FIGS. 8A and 8B. In some examples, the flux compute circuitry 520 may be instantiated by hardware logic circuitry, which may be implemented by an ASIC, XPU, or FPGA circuitry that are structured to perform operations corresponding to the machine-readable instructions. Also or alternatively, the flux compute circuitry 520 may be instantiated by any other combination of hardware, software, or firmware. For example, the flux compute circuitry 520 may be implemented by at least one or more hardware circuits (e.g., processor circuitry, discrete or integrated analog or digital circuitry, an FPGA, an ASIC, an XPU, a comparator, an operational-amplifier (op-amp), a logic circuit, etc.) configured or structured to execute some or all of the machine-readable instructions or to perform some or all of the operations corresponding to the machine-readable instructions without executing software or firmware, but other structures are likewise appropriate.

In some embodiments, the protection circuit 245 includes the stall/loading detection circuitry 525 to identify a stall condition and a loading condition of the motor 210. The stall/loading detection circuitry 525 obtains the flux magnitude and the flux angle from the flux compute circuitry 520. In some examples, the stall/loading detection circuitry 525 determines whether a stall condition has occurred based on the flux magnitude or the flux angle. For example, the stall/loading detection circuitry 525 compares the flux magnitude and/or the flux angle to a threshold flux. In some examples, the threshold flux may be a value indicative of a minimum amount of flux that the motor 210 is to generate for a running condition. In some examples, the stall/loading detection circuitry 525 determines there is a stall condition when the flux magnitude is less than the threshold flux. In some examples, the stall/loading detection circuitry 525 determines there is a stall condition when the flux angle is indeterminate. For example, when the flux angle is indeterminate, that means that the active flux Φ_{w} and reactive flux Φₓ of the motor 210 are zero.

In some examples, the stall/loading detection circuitry 525 determines a loading condition of the motor based on the flux angle. For example, the stall/loading detection circuitry 525 can determine whether the motor 210 is unloaded, partially loaded, or fully loaded based on the flux angle. The flux angle may indicate an unloaded motor 210 when the value of the flux angle is equivalent to 90 degrees. The flux angle may indicate a partially loaded motor 210 when the value of the flux angle is between 30 and 60 degrees. The flux angle may indicate a fully loaded motor 210 when the value of the flux angle is equivalent to 0 degrees.

In some embodiments, the stall/loading detection circuitry 525 provides a signal to the fault output 251 (FIG. 2) of the motor controller 205 when flux magnitude or the flux angle is indicative of a stall condition. In some examples, the stall signal enables the fault output 251 to ground the fault pin. Grounding the fault pin may indicate the stall condition to a user or may remove power to the motor 210.

In some examples, the protection circuit 245 is capable of detecting a stall condition of the motor, e.g., using stall/loading detection circuitry 525. In some examples, the stall/loading detection circuitry 525 may be instantiated by programmable circuitry executing machine executable instructions such as those implemented by at least blocks 870, 875, and 880 of FIG. 8B. In some examples, the stall/loading detection circuitry 525 may be instantiated by hardware logic circuitry, which may be implemented by an ASIC, XPU, or FPGA circuitry that are structured to perform operations corresponding to the machine-readable instructions. Also or alternatively, the stall/loading detection circuitry 525 may be instantiated by any other combination of hardware, software, or firmware. For example, the stall/loading detection circuitry 525 may be implemented by at least one or more hardware circuits (e.g., processor circuitry, discrete or integrated analog or digital circuitry, an FPGA, an ASIC, an XPU, a comparator, an operational-amplifier (op-amp), a logic circuit, etc.) configured or structured to execute some or all of the machine-readable instructions or to perform some or all of the operations corresponding to the machine-readable instructions without executing software or firmware, but other structures are likewise appropriate.

In some examples, an operation of the protection circuit 245 can be described as a set of states and transitions between those states. For example, a first state of protection circuit 245 includes a reset of variables corresponding to the stall condition of the motor. The variables are v_{A}, v_{B}, i_{A}, i_{B}, W_{S}, x_{S}, 12, Wₗₒₛₛ, Xₗₒₛₛ, Wₘₒₜₒᵣ, Xₘₒₜₒᵣ, Φ_{w}, Φₓ, and the magnitude of motor flux and the load angle. In some examples, the driver state inference circuitry 505 resets the phase voltages v_{A}, v_{B}. In some examples, the energy compute circuitry 510 resets the currents i_{A}, i_{B}, the input active energy W_{S}, the input reactive energy x_{S}, and the full scale current I². In some examples, the flux compute circuitry 520 resets the active and reactive energy losses Wₗₒₛₛ, Xₗₒₛₛ, the active and reactive energy Wₘₒₜₒᵣ, Xₘₒₜₒᵣ, and the active and reactive flux values Φ_{w}, Φₛ. In some examples, the stall/loading detection circuitry 525 resets the magnitude of motor flux and the load angle.

In response to resetting the variables, a second state of the protection circuit 245 includes computing a full scale current of the motor based on integrating the current over a period of time of one electrical cycle of the motor. For example, the energy compute circuitry 510 determines I² based on Equation 4 and multiplying I² by the period of one electrical cycle (T_{S}).

In response to determining the full scale current of the motor, a third state of the protection circuit 245 includes computing an active energy loss of the motor based on squaring the current of the motor and multiplying the squared current by the resistance value and the period of time. For example, the flux compute circuitry 520 determines Wₗₒₛₛ based on Equation 6.

In response to determining the full scale current of the motor, a fourth state of the protection circuit 245 includes computing a reactive energy loss based on squaring the current of the motor and multiplying the squared current by the self-inductance value and an angular frequency of the current of the motor. For example, the flux compute circuitry 520 determines Xₗₒₛₛ based on Equation 9.

In response to computing the active energy loss and the reactive energy loss, a fifth state of the protection circuit 245 includes computing an active component of motor flux based on obtaining an active energy of the motor from the active energy loss and an input active energy, and dividing the active energy by the full scale current of the motor. For example, the flux compute circuitry 520 determines Wₘₒₜₒᵣ based on Equation 7.

In response to computing the active energy loss and the reactive energy loss, a sixth state of the protection circuit 245 includes computing a reactive component of the motor flux based on obtaining a reactive energy from the reactive energy loss and an input reactive energy, and dividing the reactive energy by the full scale current of the motor. For example, the flux compute circuitry 520 determines Xₘₒₜₒᵣ based on Equation 10.

In response to computing the active component and reactive component of the motor flux, a seventh state of the protection circuit 245 includes computing a load angle of the motor flux based on dividing the active energy loss by the reactive energy loss. For example, the flux compute circuitry 520 determines the flux angle based on diving active and reactive flux values Φ_{w}, Φₓ.

In response to computing the load angle, an eighth state of the protection circuit 245 includes computing a magnitude of the motor flux based on squaring and adding the active component and reactive component of the motor flux. For example, the flux compute circuitry 520 determines the magnitude of the motor flux based on Equation 12.

The ninth state of the protection circuit 245 includes generating a calculation complete signal. For example, the flux compute circuitry 520 may generate a CALC DONE signal and send to the stall/loading detection circuitry 525.

In response to the calculation complete signal, a tenth state of the protection circuit includes comparing the magnitude of the motor flux to a stall threshold value to detect whether the motor is in a running condition or the stall condition. For example, the stall/loading detection circuitry 525 waits to compare the magnitude of the motor flux to the flux threshold until the CALC DONE signal is received.

FIGS. 8A and 8B are flowcharts of embodiment method 800 to detect a stall condition in an electrical motor, according to an embodiment of the present disclosure.

Method 800 begin at block 805, at which the motor controller 205 (FIG. 2) obtains voltages corresponding to a first voltage state and a second voltage state. For example, the protection circuit 245 (FIGS. 2 and 3) obtains first phase voltages V_{AOUT1}, V_{AOUT2} from the first full bridge configuration 230A corresponding to a first voltage state v_{A} and second phase voltages V_{BOUT1}, V_{BOUT2} from the second full bridge configuration 230B corresponding to the second voltage state v_{B}.

At block 810, the motor controller 205 determines a first driving operating state of a motor based on the first voltage state and a second driving operating state of the motor based on the second voltage state. For example, the protection circuit 245 and/or the driver state inference circuitry 505 (FIG. 5) determines STATE A and STATE B based on the first and second voltage states v_{A} and v_{B}. In some examples, STATE A and STATE B are in one of three states: is a positive voltage state, a zero voltage state, or a negative voltage state, wherein the motor controller 205 is configured to operate in the positive voltage state to operate the motor 210 in forward drive, operate in the zero voltage state to operate the motor 210 in slow decay, and operate in the negative voltage state to operate the motor 210 in reverse drive (fast decay).

At block 815, the motor controller 205 samples a first current through a first coil of the motor and a second current through a second coil of the motor over a time period, the first current based on the first driving operating state and the second current based on the second driving operating state. For example, the protection circuit 245 and/or the energy compute circuitry 510 (FIG. 5) samples n currents i_{A} and i_{B} over a sampling interval of one electrical cycle (T_{S}) based on requesting the ADC 240 to convert the sense currents into digital values i_{A} and i_{B} at specific sampling times x₀, x₂, x₂, . . . , xₙ. In some examples, the energy compute circuitry 510 adjusts a value of the first current is based on comparing a current driving state (e.g., STATE A at time xₙ) of the first motor phase A with a previous driving state (e.g., STATE A at time xₙ₋₁) of the first motor phase A. In some examples, the energy compute circuitry 510 adjusts a value of the second current is based on comparing a current driving state (e.g., STATE B at time xₙ) of the first motor phase B with a previous driving state (e.g., STATE B at time xₙ₋₁) of the second motor phase B. In this way, the first current i_{A} is based on the first driving operating state and the second current i based on the second driving operating state.

At block 820, the motor controller 205 determines an input active energy into the motor based on integrating the voltages, corresponding to the first and second driving operating states, and first and second currents over the time period. For example, the protection circuit 245 and/or the energy compute circuitry 510 integrates a combination of the sampled voltages corresponding to the first driving state v_{A} and the adjusted first current i_{A} plus a combination of the sampled voltage corresponding to the second driving state v_{B} and the adjusted second current i_{B} over the time period. In some examples, the energy compute circuitry 510 approximates Equation 2 above, using an approximation function such as the Trapezoidal Rule, to determine the input active energy W_{S} into the motor 210.

At block 825, the motor controller 205 determines an input reactive energy into the motor based on integrating the voltages, corresponding to the first and second driving operating states, and first and second currents over the time period. For example, the protection circuit 245 and/or the energy compute circuitry 510 integrates a combination of the sampled voltages corresponding to the second driving state v_{B} and the adjusted first current i_{A} plus a combination of the sampled voltage corresponding to the first driving state v_{A} and the adjusted second current is over the time period. In some examples, the energy compute circuitry 510 approximates Equation 3 above, using an approximation function such as the Trapezoidal Rule, to determine the input reactive energy x_{S} into the motor 210.

At block 830, the motor controller 205 determines a full scale current based on integrating the first and second currents over the time period and squaring the result. For example, the protection circuit 245 and/or the energy compute circuitry 510 obtains the sampled n currents i_{A}, i_{B} and approximates Equation 4 above to determine a total current of the motor 210. In some examples, the total current of the motor 210 is the root-mean-square (RMS) current. The energy compute circuitry 510 squares the total current to obtain the full scale current of the motor 210.

At block 835, the motor controller 205 determines an active energy loss of the motor based on the full scale current and a resistance value of the motor. For example, the protection circuit 245 and/or the flux compute circuitry 520 (FIG. 5) implements Equation 6 above to determine resistive power losses Wₗₒₛₛ of the motor 210.

At block 840, the motor controller 205 determines an active energy of the motor based on subtracting the active energy loss from the input active energy into the motor. For example, the protection circuit 245 and/or the flux compute circuitry 520 implements Equation 7 above to determine the active energy Wₘₒₜₒᵣ of the motor 210.

At block 845, the motor controller 205 determines reactive energy loss of the motor based on the full scale current, and an inductance value of the motor. For example, the protection circuit 245 and/or the flux compute circuitry 520 implements Equation 9 above to determine the reactive or inductive power loss Xₗₒₛₛ of the motor 210.

At block 850, the motor controller 205 determines a reactive energy of the motor based on subtracting the reactive energy loss from the input reactive energy into the motor. For example, the protection circuit 245 and/or the flux compute circuitry 520 implements Equation 10 above to determine the reactive energy Xₘₒₜₒᵣ of the motor 210.

At block 855, the motor controller 205 determines an active flux value based on the active energy and the current of the motor. For example, the protection circuit 245 and/or the flux compute circuitry 520 implements Equation 8 above to determine the active flux Φ_{w}.

At block 860, the motor controller 205 determines a reactive flux value based on the reactive energy and the current of the motor. For example, the protection circuit 245 and/or the flux compute circuitry 520 implements Equation 11 above to determine the reactive flux Φₓ.

At block 865, the motor controller 205 determines a flux magnitude of the motor based on the active flux and reactive flux. For example, the protection circuit 245 and/or the flux compute circuitry 520 implements Equation 12 above to determine the flux magnitude Φ_{magnitude}.

At block 870, the motor controller 205 compares the flux magnitude to a threshold. For example, the protection circuit 245 and/or the stall/loading detection circuitry 525 (FIG. 5) compares the flux magnitude to a threshold flux that may be a value indicative of a minimum amount of flux that the motor 210 is to generate for a running condition.

At block 875, the motor controller 205 determines whether the comparison satisfies a threshold. For example, the protection circuit 245 and/or the stall/loading detection circuitry 525 determines whether the flux magnitude is less than the threshold or greater than or equal to the flux threshold.

In some examples, when the motor controller 205 determines that the comparison does not satisfy the threshold (e.g., block 875 returns a value NO), the motor controller 205 determines that a stall condition has been detected (block 880). For example, the stall/loading detection circuitry 525 provides a signal to the fault output 251 (FIG. 2) when flux magnitude is indicative of a stall condition.

In some examples, when the motor controller 205 determines that the comparison satisfies the threshold (e.g., block 875 returns a value YES), the motor controller 205 determines that no stall condition has been detected (block 885). For example, the stall/loading detection circuitry 525 provides informs the fault output 251 (FIG. 2) that the motor 210 is in a running condition.

The operations 800 end when the stall/loading detection circuitry 525 does or does not detect a stall condition. In some examples, the operations 800 may be repeated for a next electrical cycle. For example, the motor controller 205 may monitor a running condition of the motor 210 every electrical cycle, so long as power is being provided to the motor 210.

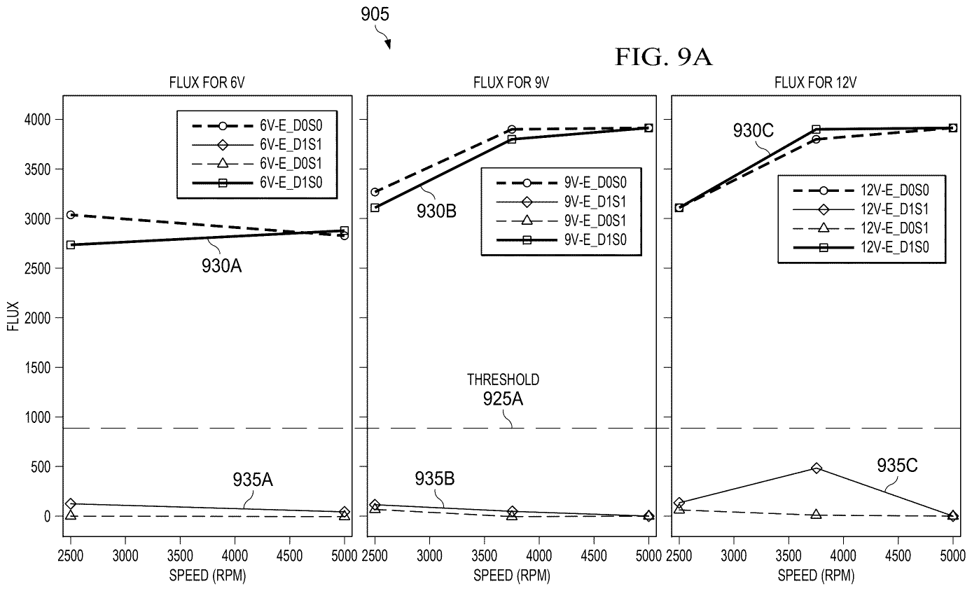

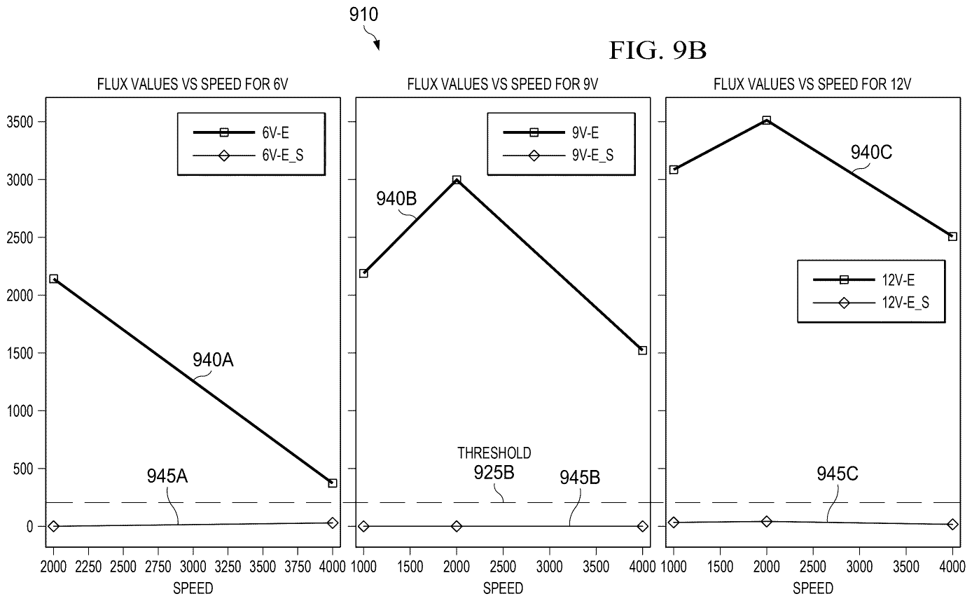

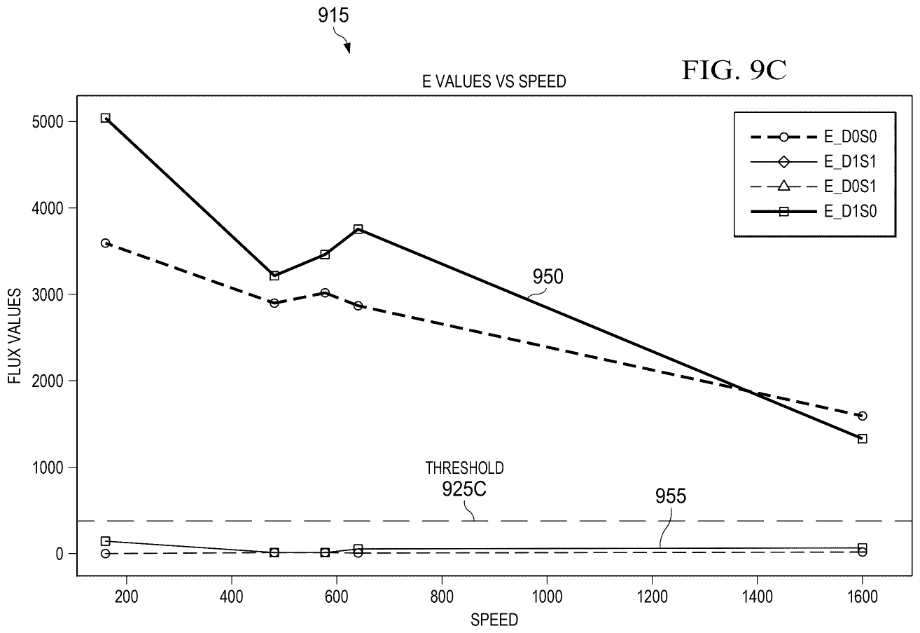

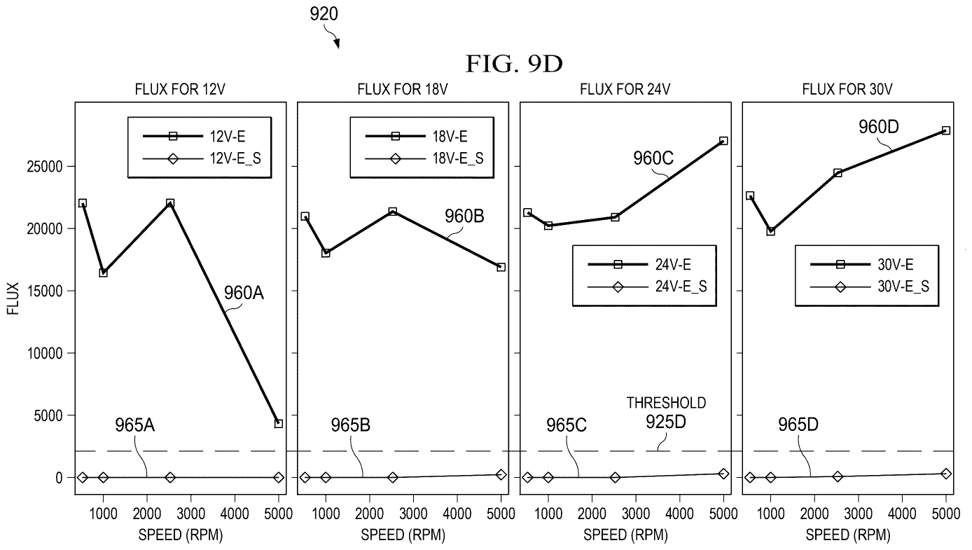

FIG. 9 illustrates example simulation results of flux values vs speed for different motors when the motor is stalled and when the motor is running. FIG. 9 includes a first simulation result 905, a second simulation result 910, a third simulation result 915, and a fourth simulation result 920. In some examples, the first simulation result 905 corresponds to a first motor, the second simulation result 910 corresponds to a second motor, the third simulation result 915 corresponds to a third motor, and the fourth simulation result 920 corresponds to a fourth motor. In FIG. 9, the simulation results 905-920 include a flux threshold 925A-D to depict the minimum amount of flux that the first motor, second motor, third motor, and fourth motor are to generate for a running condition.

In the first simulation result 905, the first motor generates first flux values 930A-C at 6V, 9V, and 12V and second flux values 935A-C at 6V, 9V, and 12V. The flux values are measured in webers (Wb) and correspond to active and reactive flux of the first motor. In some examples, the first flux values 930A-C correspond to flux of the first motor when the motor is in a running condition. For example, the first flux values 930A-C vary between 2500 Wb and 4000 Wb when the first motor is in a running condition. The second flux values 935A-C correspond to the flux generated by the first motor when the first motor is stalled. The second flux values 935A-C are below the flux threshold 925A and vary between 0 and 500 Wb. The motor controller 205 (FIG. 2) uses the flux threshold 925A to determine when the first motor is running or stalled across any motor voltage.

In the second simulation result 910, the second motor generates third flux values 940A-C at 6V, 9V, and 12V and fourth flux values 945A-C at 6V, 9V, and 12V. In some examples, the third flux values 940A-C correspond to flux of the second motor when the motor is in a running condition. For example, the third flux values 940A-C vary between 500 Wb and 3500 Wb when the second motor is in a running condition. The fourth flux values 945A-C correspond to the flux generated by the second motor when the second motor is stalled. For example, the fourth flux values 945A-C are below the flux threshold 925B and are approximately 0 Wb. The example motor controller 205 (FIG. 2) uses the flux threshold 925B for the second motor to determine when the second motor is running or stalled across any motor voltage.

In the third simulation result 915, the third motor generates fifth flux values 950 and sixth flux values 955. In some examples, the fifth flux values 950 correspond to flux of the third motor when the third motor is in a running condition. For example, the fifth flux values 950 vary between 1000 Wb and 5000 Wb when the third motor is in a running condition. The sixth flux values 955 correspond to the flux generated by the third motor when the third motor is stalled. For example, the sixth flux values 955 are below the flux threshold 925C and are approximately 0 Wb. The example motor controller 205 (FIG. 2) uses the flux threshold 925C for the third motor to determine when the third motor is running or stalled across any motor voltage.

In the fourth simulation result 920, the fourth motor generates seventh flux values 960A-D at 12V, 18V, 24V, and 30V and eighth flux values 965A-D at 12V, 18V, 24V, and 30V. In some examples, the seventh flux values 960A-D correspond to flux of the fourth motor when the motor is in a running condition. For example, the seventh flux values 960A-D vary between 4500 Wb and 30000 Wb when the fourth motor is in a running condition. The eighth flux values 965A-D correspond to the flux generated by the fourth motor when the fourth motor is stalled. For example, the eighth flux values 965A-D are below the flux threshold 925D and are approximately 0 Wb. The example motor controller 205 (FIG. 2) uses the flux threshold 925D for the fourth motor to determine when the fourth motor is running or stalled across any motor voltage.

While an example manner of implementing the protection circuit 245 of FIG. 2 is illustrated in FIG. 5, one or more of the elements, processes, or devices illustrated in FIG. 5 may be combined, divided, re-arranged, omitted, eliminated, or implemented in any other way. Further, the example protection circuit 245 of FIG. 5, may be implemented by hardware alone or by hardware in combination with software and firmware. Thus, for example, the protection circuit 245 of FIG. 5, could be implemented by programmable circuitry in combination with one or more machine-readable instructions (for example, firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example protection circuit 245 of FIG. 5 may include one or more elements, processes, or devices in addition to, or instead of, those illustrated in FIG. 5, or may include more than one of any or all of the illustrated elements, processes and devices.

Flowchart(s) representative of steps, which may be executed by programmable circuitry to at least one of implement or instantiate the protection circuit 245 of FIG. 5 or representative of example operations which may be performed by programmable circuitry to at least one of implement or instantiate the protection circuit 245 of FIG. 5, are shown in FIGS. 8A-8B. If the steps are implemented as machine-readable instructions, the machine-readable instructions may be one or more executable programs or portion(s) of one or more executable programs for execution by programmable circuitry, such as a generic or custom processor. In some embodiments, one or more function(s) or portion(s) of functions to be performed by the programmable circuitry (for example, an FPGA).

As mentioned herein, the example operations of FIGS. 8A-8B may be implemented using executable instructions (for example, at least one of computer-readable or machine-readable instructions) stored on one or more non-transitory computer-readable or machine-readable media. As used herein, the terms non-transitory computer-readable medium, non-transitory computer-readable storage medium, non-transitory machine-readable medium, and non-transitory machine-readable storage medium are expressly defined to include any type of computer-readable storage device or storage disk and to exclude propagating signals and to exclude transmission media. Examples of such non-transitory computer-readable medium, non-transitory computer-readable storage medium, non-transitory machine-readable medium, or non-transitory machine-readable storage medium include flash memory, registers and/or flip-flops, read-only memory (ROM), etc.

Circuits described herein may be reconfigurable to include replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated.

As used herein, “approximately,” “about,” and “substantially” modify their subjects/values to recognize the potential presence of variations that occur in real world applications. For example, “approximately,” “about,” and “substantially” may modify dimensions or positions that may not be exact due to at least one of manufacturing tolerances or other real-world imperfections. For example, “approximately,” “about,” and “substantially” may indicate such dimensions or positions may be within a tolerance range of +/−10% unless otherwise specified herein, or, if the value is zero, a reasonable range of values around zero.

Modifications are possible in the described examples, and other examples are possible, within the scope of the claims.

From the foregoing, it will be appreciated that example systems, apparatus, articles of manufacture, and methods have been described that provide a sensorless stall detection method that works reliably across any supply voltage, operating speed, and/or loading condition. Described systems, apparatus, articles of manufacture, and methods are also directed to one or more improvement(s) in the operation of a machine such as a computer or other electronic, electromechanical, or mechanical device.

Example embodiments of the present disclosure are summarized here. Other embodiments can also be understood from the entirety of the specification and the claims filed herein.
Example 1. An electronic circuit including: a first terminal configured to be coupled to a motor; and a controller configured to: determine a driving state of the motor; determine a current flowing through a coil of the motor based on the driving state; compute energy losses of the motor based on a resistance value of the motor, a self-inductance value of the motor, and the current; and detect a stall condition of the motor based on the energy losses, the current, and the driving state.
Example 2. The electronic circuit of example 1, where the controller is configured to integrate a voltage corresponding to the driving state of the motor and current over a time period of one electrical cycle to determine an input active energy flowing into the motor and an input reactive energy flowing into the motor, where the input active energy flowing into the motor includes an active energy of the motor and an active loss of the motor, and the input reactive energy into the motor includes a reactive energy of the motor and a reactive loss of the motor.
Example 3. The electronic circuit of one of examples 1 or 2, where the energy losses of the motor includes the active loss, the controller is configured to: integrate the current over the time period to obtain a full scale current of the motor; square the full scale current of the motor; and determine the active loss based on the squared full scale current and the resistance value of the motor.
Example 4. The electronic circuit of one of examples 1 to 3, where the energy losses of the motor includes the reactive loss, and the controller is configured to: integrate the current over the time period to obtain a full scale current of the motor; square the full scale current of the motor; and determine the reactive loss based on the squared full scale current and the self-inductance value of the motor.
Example 5. The electronic circuit of one of examples 1 to 4, where the controller is configured to use the energy losses, the current, and the driving state to determine a magnitude of motor flux, where the magnitude of motor flux is indicative of the stall condition.
Example 6. The electronic circuit of one of examples 1 to 5, where the controller is configured to determine the magnitude of motor flux based on obtaining an active energy of the motor from the energy losses and a reactive energy of the motor from the energy losses.
Example 7. The electronic circuit of one of examples 1 to 6, where the controller is configured to compare the magnitude of the motor flux to a threshold value to detect the stall condition of the motor.
Example 8. The electronic circuit of one of examples 1 to 7, where the controller is configured to: sample a voltage corresponding to a first driving state of a first motor phase and a first current flowing through the first motor phase over a first time period; adjust a value of the first current based on comparing a current driving state of the first motor phase with a previous driving state of the first motor phase; sample a voltage corresponding to a second driving state of a second motor phase and a second current flowing through the second motor phase over the first time period; and adjust a value of the second current based on comparing a current driving state of the second motor phase with a previous driving state of the second motor phase.
Example 9. The electronic circuit of one of examples 1 to 8, where the first driving state is a positive voltage state, a zero voltage state, or a negative voltage state, where the controller is configured to: operate in the positive voltage state to operate the motor in forward drive; operate in the zero voltage state to operate the motor is slow decay; and operate in the negative voltage state to operate the motor in reverse drive.
Example 10. The electronic circuit of one of examples 1 to 9, where the first time period corresponds to a time period of one electrical cycle.
Example 11. The electronic circuit of one of examples 1 to 10, where the controller is configured to determine an input active energy of the motor based on integrating a combination of the sampled voltage corresponding to the first driving state and the adjusted first current plus a combination of the sampled voltage corresponding to the second driving state and the adjusted second current over the first time period.
Example 12. The electronic circuit of one of examples 1 to 11, where the controller is configured to determine an input reactive energy of the motor based on integrating a combination of the sample voltage corresponding to the second driving state and the adjusted first current minus a combination of the sampled voltage corresponding to the first driving state and the adjusted second current over the first time period.
Example 13. The electronic circuit of one of examples 1 to 12, where the controller is further configured to: reset variables corresponding to the stall condition of the motor; in response to resetting the variables: compute a full scale current of the motor based on integrating the current over a period of time of one electrical cycle of the motor; compute an active energy loss of the motor based on squaring the current of the motor and multiplying the squared current by the resistance value and the period of time; and compute a reactive energy loss based on squaring the current of the motor and multiplying the squared current by the self-inductance value and an angular frequency of the current of the motor; in response to computing the active energy loss and the reactive energy loss: compute an active component of motor flux based on obtaining an active energy of the motor from the active energy loss and an input active energy, and dividing the active energy by the full scale current of the motor; and compute a reactive component of the motor flux based on obtaining a reactive energy from the reactive energy loss and an input reactive energy, and dividing the reactive energy by the full scale current of the motor; in response to computing the active component and reactive component of the motor flux, compute a load angle of the motor flux based on dividing the active energy loss by the reactive energy loss; in response to computing the load angle, compute a magnitude of the motor flux based on squaring and adding the active component and reactive component of the motor flux; generate a calculation complete signal; and in response to the calculation complete signal, compare the magnitude of the motor flux to a stall threshold value to detect whether the motor is in a running condition or the stall condition.
Example 14. The electronic circuit of one of examples 1 to 13, further including determining a load angle of the motor, the load angle corresponding to an angle between a back electromotive force of the motor and the current flowing through the coil of the motor and indicative of whether the motor is heavily loaded or lightly loaded.
Example 15. A device including: a driver configured to be coupled to a motor; and a controller configured to: determine a first current flowing through a first coil of the motor when the driver applies a first voltage to the first coil; determine a second current flowing through a second coil when the driver applies a second voltage to the second coil of the motor; determine an active energy of the motor and a reactive energy of the motor based on the first voltage, the first current, the second voltage, and second current; and determine a stall condition of the motor based on the active energy and reactive energy.
Example 16. The device of example 15, where the controller is configured to: determine a magnitude of motor flux based on the active energy and reactive energy; and determine the stall condition of the motor based on the motor flux.
Example 17. The device of one of examples 15 or 16, further including sensing circuitry configured to be coupled between an input of the motor and the controller.
Example 18. The device of one of examples 15 to 17, where the sensing circuitry is configured to determine the first and second currents.
Example 19. The device of one of examples 15 to 18, further including an analog to digital converter (ADC) coupled between the sensing circuitry and the controller, where the ADC is configured to: obtain a conversion start signal from the controller; convert the first current to first digital values; and convert the second current to second digital values, where the controller is configured to sample the first digital values and the second digital values over a time period to determine a full scale current of the motor, where the controller is configured to use the full scale current of the motor to determine the active energy and reactive energy of the motor.
Example 20. The device of one of examples 15 to 19, where the controller is further configured to use a resistance value of the motor and an inductance value of the motor to compute resistive and inductive energy losses of the motor to determine the active energy of the motor and the reactive energy of the motor, the active energy of the motor resulting from an active energy flowing into the motor and the resistive energy loss, the reactive energy of the motor resulting from the reactive energy flowing into the motor and the inductive energy loss.
Example 21. The device of one of examples 15 to 20, further including the motor, where the motor is a stepper motor.
Example 22. A method including: determining, by a controller, a driving operating state of a motor; sensing a current flowing through a coil of the motor based on the driving operating state; computing, by the controller, energy losses of the motor based on a resistance value of the motor, a self-inductance value of the motor, and the current; and detecting a stall condition of the motor based on the energy losses, the current, and the driving operating state.
Example 23. The method of example 22, where detecting the stall condition further includes: integrating voltage corresponding to the driving operating state and current over a time period of one electrical cycle to determine an energy flowing into the motor; and determining a difference between the energy flowing into the motor and the energy losses of the motor to obtain an energy of the motor; and dividing the energy of the motor by the current to obtain a flux of the motor, the flux of the motor indicative of the stall condition.
Example 24. The method of one of examples 22 or 23, further including comparing the flux of the motor to a threshold indicative of the stall condition of the motor.
Example 25. The method of one of examples 22 to 24, further including: sampling the sensed current over a time period; integrating the sampled current to obtain a full scale current of the motor; and determining the energy losses of the motor based on the full scale current, the resistance value, and the self-inductance value.
Example 26. The method of one of examples 22 to 25, where the energy losses of the motor include a resistive energy loss and an inductive energy loss, the resistive energy loss proportional to the square of full scale current and the resistance value, the inductive energy loss proportional to the square of the full scale current of the motor and the inductance value.
Example 27. The method of one of examples 22 to 26, further including receiving, by a controller the resistance value of the motor and the inductance value of the motor.
Example 28. The method of one of examples 22 to 27, further including: determining a loading condition of the motor based on the energy losses, the current, and the driving operating state; and detecting the stall condition independent of the loading condition and the driving operating state of the motor.

While this disclosure has been described with reference to illustrative embodiments, this description is not limiting. Various modifications and combinations of the illustrative embodiments, as well as other embodiments, will be apparent to persons skilled in the art upon reference to the description.

What is claimed is:

1. An electronic circuit comprising:
a first terminal configured to be coupled to a motor; and
a controller configured to:
determine a driving state of the motor;
determine a current flowing through a coil of the motor based on the driving state;
compute energy losses of the motor based on a resistance value of the motor, a self-inductance value of the motor, and the current; and
detect a stall condition of the motor based on the energy losses, the current, and the driving state.

2. The electronic circuit of claim 1, wherein the controller is configured to integrate a voltage corresponding to the driving state of the motor and current over a time period of one electrical cycle to determine an input active energy flowing into the motor and an input reactive energy flowing into the motor, wherein the input active energy flowing into the motor comprises an active energy of the motor and an active loss of the motor, and the input reactive energy into the motor comprises a reactive energy of the motor and a reactive loss of the motor.

3. The electronic circuit of claim 2, wherein the energy losses of the motor includes the active loss, the controller is configured to:
integrate the current over the time period to obtain a full scale current of the motor;
square the full scale current of the motor; and
determine the active loss based on the squared full scale current and the resistance value of the motor.

4. The electronic circuit of claim 2, wherein the energy losses of the motor includes the reactive loss, and the controller is configured to:
integrate the current over the time period to obtain a full scale current of the motor;
square the full scale current of the motor; and
determine the reactive loss based on the squared full scale current and the self-inductance value of the motor.

5. The electronic circuit of claim 1, wherein the controller is configured to use the energy losses, the current, and the driving state to determine a magnitude of motor flux, wherein the magnitude of motor flux is indicative of the stall condition.

6. The electronic circuit of claim 5, wherein the controller is configured to determine the magnitude of motor flux based on obtaining an active energy of the motor from the energy losses and a reactive energy of the motor from the energy losses.

7. The electronic circuit of claim 5, wherein the controller is configured to compare the magnitude of the motor flux to a threshold value to detect the stall condition of the motor.

8. The electronic circuit of claim 1, wherein the controller is configured to:
sample a voltage corresponding to a first driving state of a first motor phase and a first current flowing through the first motor phase over a first time period;
adjust a value of the first current based on comparing a current driving state of the first motor phase with a previous driving state of the first motor phase;
sample a voltage corresponding to a second driving state of a second motor phase and a second current flowing through the second motor phase over the first time period; and
adjust a value of the second current based on comparing a current driving state of the second motor phase with a previous driving state of the second motor phase.

9. The electronic circuit of claim 8, wherein the first driving state is a positive voltage state, a zero voltage state, or a negative voltage state, wherein the controller is configured to:
operate in the positive voltage state to operate the motor in forward drive;
operate in the zero voltage state to operate the motor is slow decay; and
operate in the negative voltage state to operate the motor in reverse drive.

10. The electronic circuit of claim 8, wherein the first time period corresponds to a time period of one electrical cycle.

11. The electronic circuit of claim 8, wherein the controller is configured to determine an input active energy of the motor based on integrating a combination of the sampled voltage corresponding to the first driving state and the adjusted first current plus a combination of the sampled voltage corresponding to the second driving state and the adjusted second current over the first time period.

12. The electronic circuit of claim 8, wherein the controller is configured to determine an input reactive energy of the motor based on integrating a combination of the sample voltage corresponding to the second driving state and the adjusted first current minus a combination of the sampled voltage corresponding to the first driving state and the adjusted second current over the first time period.

13. The electronic circuit of claim 1, wherein the controller is further configured to:
reset variables corresponding to the stall condition of the motor;
in response to resetting the variables:
compute a full scale current of the motor based on integrating the current over a period of time of one electrical cycle of the motor;
compute an active energy loss of the motor based on squaring the current of the motor and multiplying the squared current by the resistance value and the period of time; and
compute a reactive energy loss based on squaring the current of the motor and multiplying the squared current by the self-inductance value and an angular frequency of the current of the motor;
in response to computing the active energy loss and the reactive energy loss:
compute an active component of motor flux based on obtaining an active energy of the motor from the active energy loss and an input active energy, and dividing the active energy by the full scale current of the motor; and
compute a reactive component of the motor flux based on obtaining a reactive energy from the reactive energy loss and an input reactive energy, and dividing the reactive energy by the full scale current of the motor;
in response to computing the active component and reactive component of the motor flux, compute a load angle of the motor flux based on dividing the active energy loss by the reactive energy loss;
in response to computing the load angle, compute a magnitude of the motor flux based on squaring and adding the active component and reactive component of the motor flux;
generate a calculation complete signal; and
in response to the calculation complete signal, compare the magnitude of the motor flux to a stall threshold value to detect whether the motor is in a running condition or the stall condition.

14. The electronic circuit of claim 1, further including determining a load angle of the motor, the load angle corresponding to an angle between a back electromotive force of the motor and the current flowing through the coil of the motor and indicative of whether the motor is heavily loaded or lightly loaded.

15. A device comprising:
a driver configured to be coupled to a motor; and
a controller configured to:
determine a first current flowing through a first coil of the motor when the driver applies a first voltage to the first coil;
determine a second current flowing through a second coil when the driver applies a second voltage to the second coil of the motor;
determine an active energy of the motor and a reactive energy of the motor based on the first voltage, the first current, the second voltage, and second current; and
determine a stall condition of the motor based on the active energy and reactive energy.

16. The device of claim 15, wherein the controller is configured to:
determine a magnitude of motor flux based on the active energy and reactive energy; and
determine the stall condition of the motor based on the motor flux.

17. The device of claim 15, further including sensing circuitry configured to be coupled between an input of the motor and the controller.

18. The device of claim 17, wherein the sensing circuitry is configured to determine the first and second currents.

19. The device of claim 17, further including an analog to digital converter (ADC) coupled between the sensing circuitry and the controller, wherein the ADC is configured to:
obtain a conversion start signal from the controller;
convert the first current to first digital values; and
convert the second current to second digital values, wherein the controller is configured to sample the first digital values and the second digital values over a time period to determine a full scale current of the motor, wherein the controller is configured to use the full scale current of the motor to determine the active energy and reactive energy of the motor.

20. The device of claim 15, wherein the controller is further configured to use a resistance value of the motor and an inductance value of the motor to compute resistive and inductive energy losses of the motor to determine the active energy of the motor and the reactive energy of the motor, the active energy of the motor resulting from an active energy flowing into the motor and the resistive energy loss, the reactive energy of the motor resulting from the reactive energy flowing into the motor and the inductive energy loss.

21. The device of claim 15, further comprising the motor, wherein the motor is a stepper motor.
